(19) United States
(12) Patent Application Publication
(10) Pub. No.: US 2017/0158015 A1
(43) Pub. Date: Jun. 8, 2017

(54) Signal Processing Device, Suspension Control Device, and Signal Processing Method

(71) Applicant: KYB CORPORATION, Tokyo (JP)

(72) Inventors: Tomoo Kubota, Tokyo (JP); Masatoshi Okumura, Tokyo (JP)

(21) Appl. No.: 15/321,573

(22) PCT Filed: Jun. 24, 2015
(86) PCT No.: PCT/JP2015/068165

§ 371 Date: Dec. 22, 2016

(30) Foreign Application Priority Data
Jul. 8, 2014 (JP) 2014-140585

(51) Int. Cl. B60G 17/018; B60G 17/0165; B60G 17/016

(52) U.S. Cl. CPC B60G 17/018; B60G 17/0164; B60G 17/0165

(57) ABSTRACT

A damper speed calculation unit 42 reads a suspension displacement and performs a differential operation on it, to thereby calculate a damper speed. This differential operating characteristic includes a gain characteristic having a gradient larger than a gradient of a gain characteristic of an exact differential in an unsprung resonance frequency region. With this, the phase delay is suppressed and the control performance is enhanced.

### TECHNICAL FIELD

The present invention relates to a suspension control device that controls a suspension of a vehicle, a signal processing device used therefor, and a method therefor.

### BACKGROUND ART

Conventionally, there is an active suspension system as a suspension system for a vehicle. The active suspension system actively controls a suspension on the basis of skyhook theory, to thereby give both riding comfort and a good steering stability. A semi-active suspension system is one of such active suspension systems. The semi-active suspension system uses a shock absorber (damper) having a variable damping force (strictly speaking, damping characteristic) and variably controls the damping characteristic when the damping force acts in a damping direction.

Patent Document 1 describes an example in which a damper displacement detected by a damper displacement sensor is filtered through a differential filter to be time-differentiated for determining a damper speed, and, using this damper speed, a target current supplied to a damper is calculated by map search. In this case, when the differential filter is designed to minimize a phase delay for reliably controlling also an unsprung resonance frequency region, high-frequency noise occurs in a damper speed signal to be output (e.g., see paragraph [0004] in Patent Document 1).

Patent Document 1: Japanese Patent Application Laid-open No. 2006-273222

### SUMMARY OF INVENTION

### Problem to be Solved by the Invention

For removing such high-frequency noise, a device described in Patent Document 1 filters a signal of a target current that is a control amount through a low-pass filter that allows the unsprung resonance frequency region to pass therethrough However, when the control amount is subjected to the low-pass filtering, a phase delay still occurs in this control amount, which leads to a problem in that the control performance is lowered.

Thus, it is an object of the present invention to provide a suspension control device whose control performance is enhanced by reducing a phase delay, and signal processing device and signal processing method used therefor.

### Means for Solving the Problem

In order to accomplish the above object, a signal processing device according to an embodiment of the present invention is a signal processing device that reads a suspension displacement and outputs a damper speed and includes a damper speed calculation unit. The damper speed calculation unit is configured to differentiate the suspension displacement, using a differential operating characteristic including a gain characteristic having a gradient larger than a gradient of a gain characteristic of an exact differential in an unsprung resonance frequency region.

With this, in vibration control performed by the suspension control device including this signal processing device, a phase delay of the damper speed in the unsprung resonance frequency region can be reduced, and hence the control performance is enhanced.

The damper speed calculation unit may use the differential operating characteristic further including a gain characteristic having a gradient smaller than the gradient of the gain characteristic of the exact differential in a frequency region between a sprung resonance frequency region and the unsprung resonance frequency region.

With this, the gain can be prevented from being larger than the gain of the exact differential, i.e., the gain of the original damper speed in the unsprung resonance frequency region. Further, the phase in the unsprung resonance frequency region can be made closer to the original phase of the damper speed.

The damper speed calculation unit may use a differential operating characteristic including a phase characteristic having a phase that becomes the same as a phase of the exact differential in the unsprung resonance frequency region.

In other words, the phase characteristic including the original phase of the damper speed can be obtained in the unsprung resonance frequency region.

A low-pass operation unit into which the damper speed from the damper speed calculation unit is input may be further provided, the low-pass operation unit having a cutoff frequency variable according to vehicle motion information.

Noise components contained in the damper speed can be removed by the low-pass operation unit. Further, a cutoff frequency thereof is variable, and hence it is possible to adaptively divide, according to the vehicle motion information, a situation where the output accuracy for the damper speed is prioritized and a situation where the noise removal is prioritized. Thus, the control performance is enhanced.

A switching unit that switches on and off the low-pass operation unit on the basis of a cutoff frequency calculated according to the vehicle motion information may be further provided.

With this, suitable damper speed information is obtained according to the vehicle motion information and the control performance is further enhanced.

The signal processing device may further include a low-pass operation unit into which the suspension displacement is input, the low-pass operation unit having a cutoff frequency variable according to vehicle motion information. Further, the suspension displacement subjected to a low-pass operation by the low-pass operation unit may be input into the damper speed calculation unit.

Noise components contained in the damper speed information can be removed by the low-pass operation unit. Further, a cutoff frequency thereof is variable, and hence it is possible to adaptively divide, according to the vehicle motion information, a situation where the output accuracy (calculation accuracy) for the damper speed is prioritized and a situation where the noise removal is prioritized. Thus, the control performance is enhanced.

The signal processing device may further include a calculator that calculates an unsprung vibration level as the vehicle motion information.

With this, the low-pass operation unit can change the cutoff frequency on the basis of the unsprung vibration level.

The calculator may calculate the unsprung vibration level on the basis of unsprung acceleration.

That is, the calculator does not calculate the vibration level on the basis of the damper speed as described above but calculates the unsprung vibration level on the basis of the unsprung acceleration. Therefore, it is possible to reliably detect an unsprung vibration and adaptively divide a situation where the output accuracy for the damper speed is prioritized and a situation where the noise removal is prioritized. Thus, the control performance is enhanced.

The calculator may include a low-pass filter unit having a cutoff frequency variable according to unsprung acceleration.

The calculator may calculate the unsprung vibration level on the basis of the damper speed calculated by the damper speed calculation unit.

In accordance with the present invention, it is unnecessary to provide the unsprung acceleration sensor, and hence the cost increase is prevented.

The calculator may include a low-pass filter unit having a cutoff frequency variable according to the damper speed calculated by the damper speed calculation unit as described above.

The S/N ratio may be lowered with some magnitudes of the damper speed. In this case, the unsprung vibration level is likely to fluctuate. There is a fear in that this fluctuation may affect a result of output of a final damper speed. In accordance with the present invention, the filter unit of the calculator has the cutoff frequency variable according to the damper speed, and hence the fluctuation of the unsprung vibration level is reduced, and the signal processing device can finally output a damper speed with the reduced fluctuation.

The low-pass operation unit may calculate the cutoff frequency on the basis of a plurality of types of vehicle motion information.

The low-pass operation unit obtains a plurality of types of vehicle motion information, and hence can output a highly accurate damper speed in a suitable manner depending on situations.

The low-pass operation unit may calculate a cutoff frequency on the basis of an unsprung vibration level and a damping coefficient-corresponding value corresponding to a change in damping coefficient of a damper.

With this, the signal processing device can perform an arithmetic operation using not only the unsprung vibration level but also the damping coefficient of the damper corresponding to the damping coefficient-corresponding value. With this, it is possible to calculate the damper speed in a state closer to the actual characteristic. Thus, the output accuracy for the damper speed is enhanced and the control performance is enhanced.

The low-pass operation unit may calculate a cutoff frequency on the basis of a cutoff frequency calculated on the basis of the unsprung vibration level and a cutoff frequency calculated on the basis of the damping coefficient-corresponding value.

The low-pass operation unit may include a low selector that outputs the cutoff frequency through low select processing.

The low-pass operation unit may calculate a ratio value on the basis of the damping coefficient-corresponding value, and may include a multiplier that multiplies a reference cutoff frequency by the ratio value, the reference cutoff frequency being calculated on the basis of the unsprung vibration level.

The low-pass operation unit may calculate a ratio value on the basis of the unsprung vibration level, and may include a multiplier that multiplies a reference cutoff frequency by the ratio value, the reference cutoff frequency being calculated on the basis of the damping coefficient-corresponding value.

The signal processing device may further include a plurality of low-pass filters that each perform low-pass filtering on the damper speed from the damper speed calculation unit at a plurality of different cutoff frequencies, and a switching means that selectively switches between the plurality of low-pass filters for use according to vehicle motion information.

With this, it is possible to reduce the amount of information processing used in signal processing and simplify the control.

The damper speed calculation unit may use the differential operating characteristic further including a band elimination filter characteristic in a frequency region higher in frequency than the unsprung resonance frequency region.

With this, it is possible to achieve both of compensation for the phase delay of the damper speed in the unsprung resonance frequency region and the high-frequency noise removal. Thus, the control performance is enhanced.

The damper speed calculation unit may use the differential operating characteristic further including the band elimination filter characteristics arranged in series at respective frequencies higher in frequency than the unsprung resonance frequency region.

With this, the effects of the above-mentioned phase delay compensation and high-frequency noise removal can be promoted.

The damper speed calculation unit may use the differential operating characteristic further including a high-pass filter characteristic having a cutoff frequency lower than that of the sprung resonance frequency region.

With this, the phase characteristic in the sprung resonance frequency region can be made closer to the phase characteristic in the exact differential. In other words, the phase characteristic having the original phase of the damper speed can be obtained in the sprung resonance frequency region.

A suspension control device according to an embodiment of the present invention includes the above-mentioned damper speed calculation unit and a control computing unit that generates a control command value for controlling a damper on the basis of the damper speed.

With this, in vibration control performed by the suspension control device, a phase delay of the damper speed in the unsprung resonance frequency region can be reduced, and hence the control performance is enhanced.

A signal processing method according to an embodiment of the present invention includes reading a suspension displacement.

Further, the read suspension displacement is differentiated using a differential operating characteristic including a gain characteristic having a gradient larger than a gradient of a gain characteristic of an exact differential in an unsprung resonance frequency region.

### Effects of the Invention

As described above, according to the present invention, the phase delay is reduced and the control performance is enhanced.

### BRIEF DESCRIPTION OF DRAWINGS

FIG. 1 is a block diagram showing a suspension control system according to an embodiment of the present invention.

FIG. 2 is a block diagram showing a configuration of a suspension displacement processor according to Embodiment 1.

A and B of FIG. 3 are bode plots that are differential operating characteristics of the damper speed calculation unit.

FIG. 4 is a flowchart showing an operation of the suspension displacement processor according to Embodiment 1.

FIG. 5 shows another example of the damper speed calculation unit as a configuration of a suspension displacement processor according to Embodiment 2.

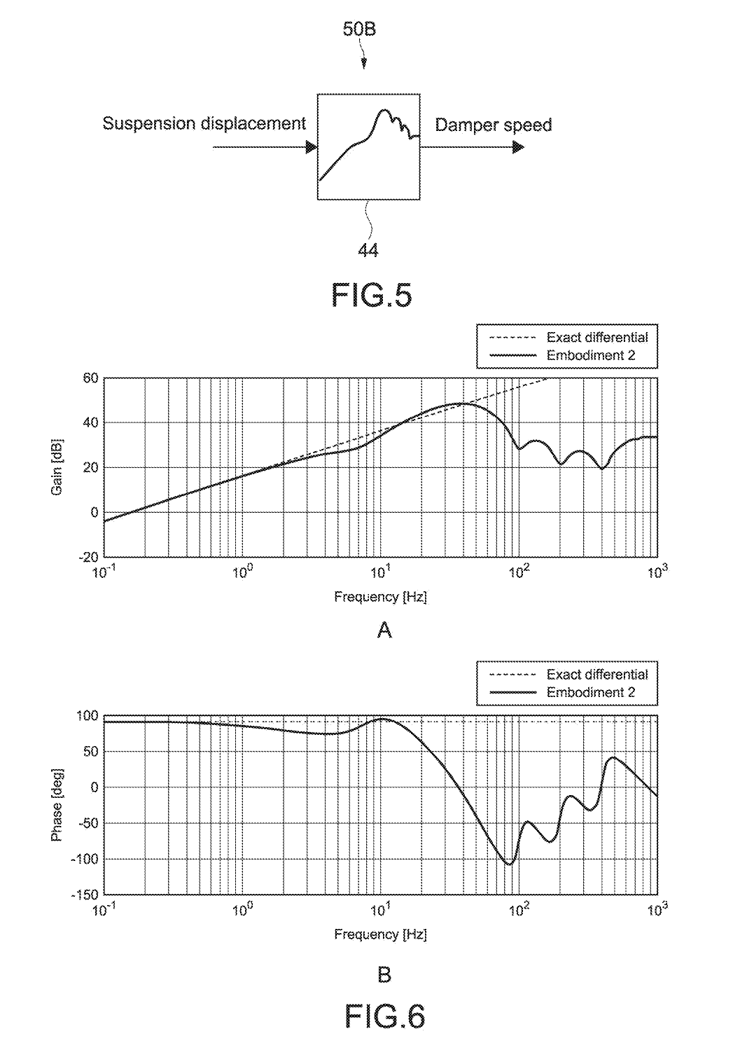

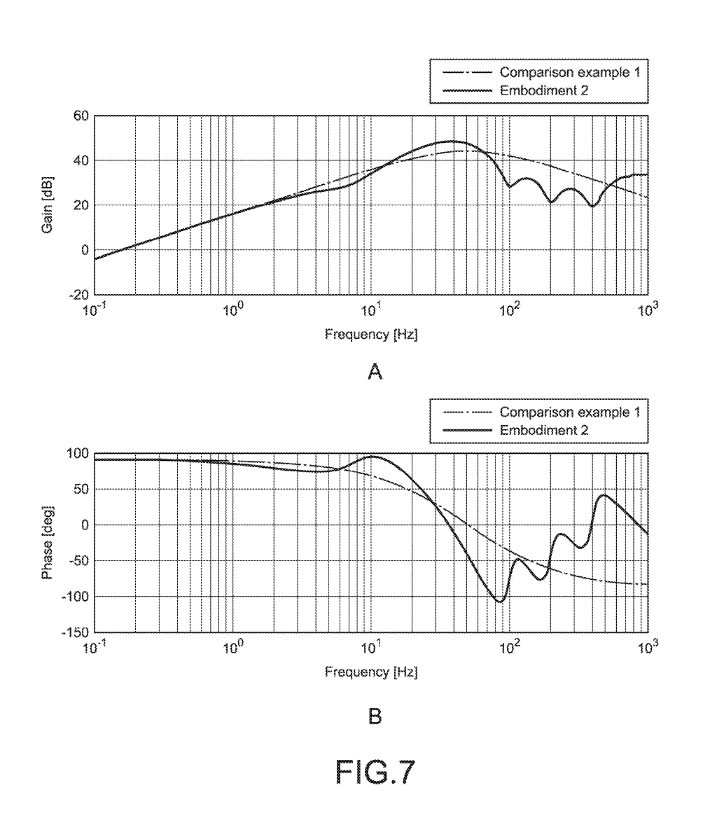

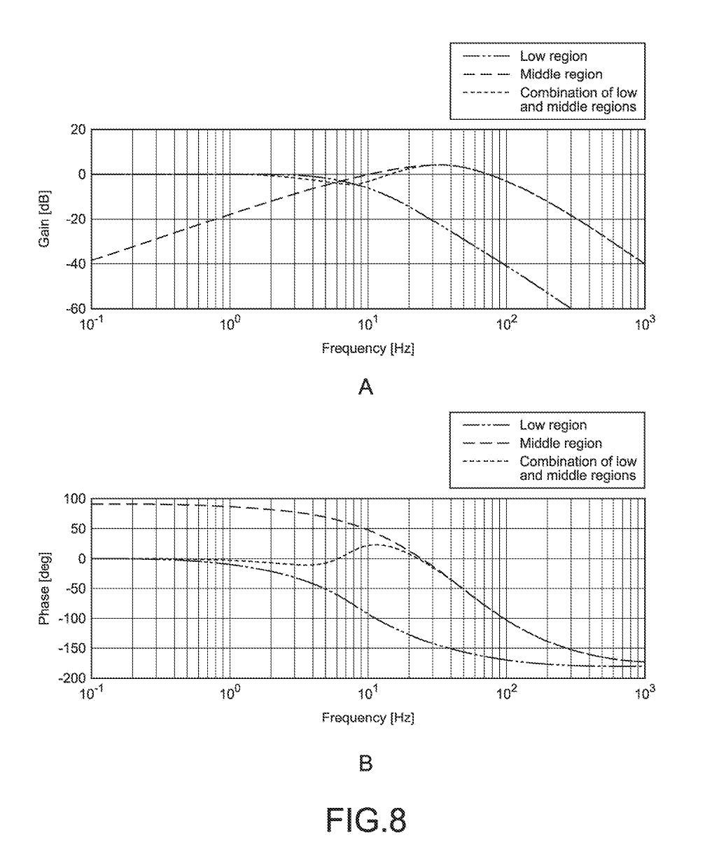

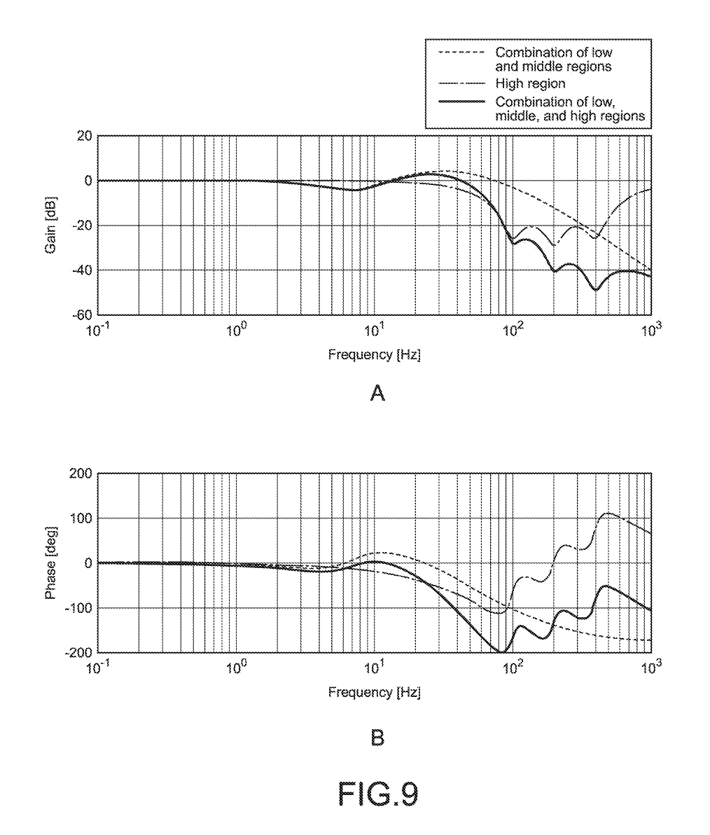

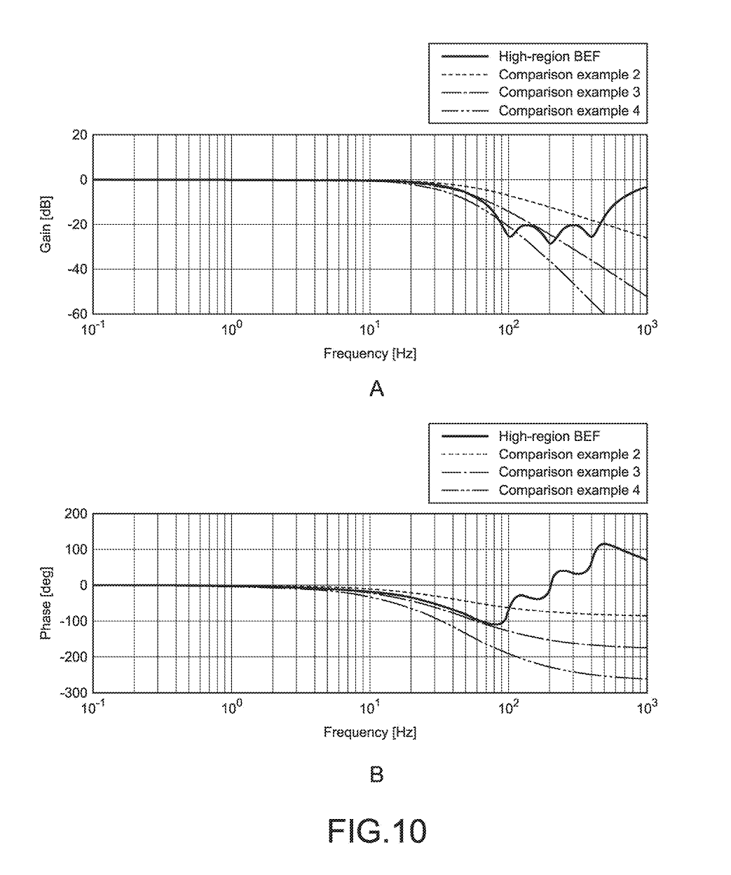

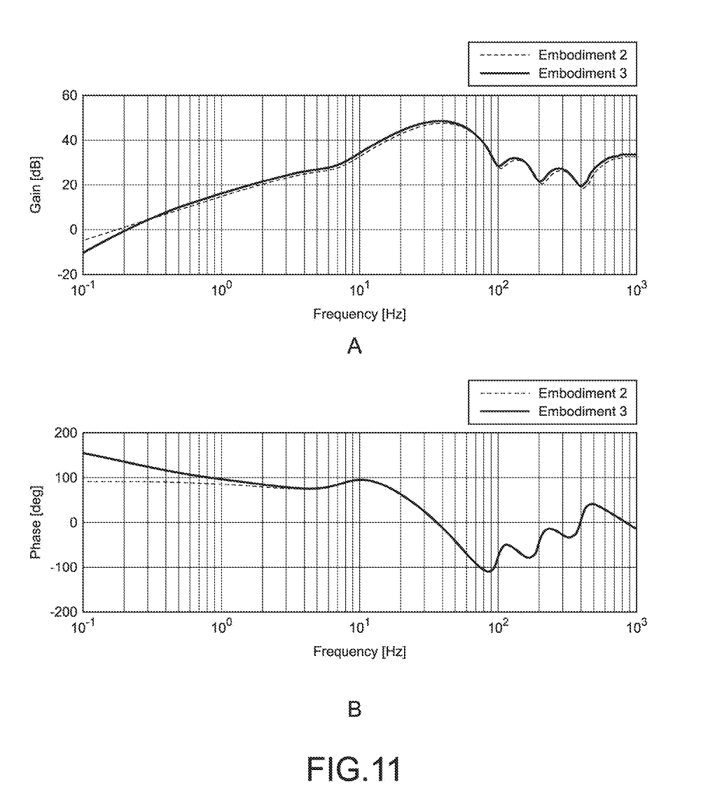

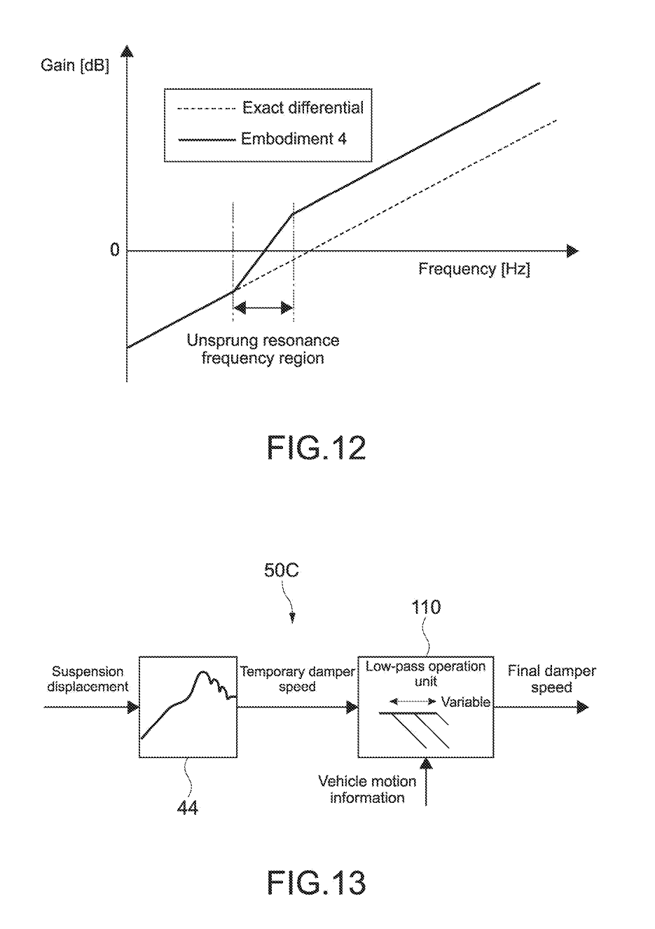

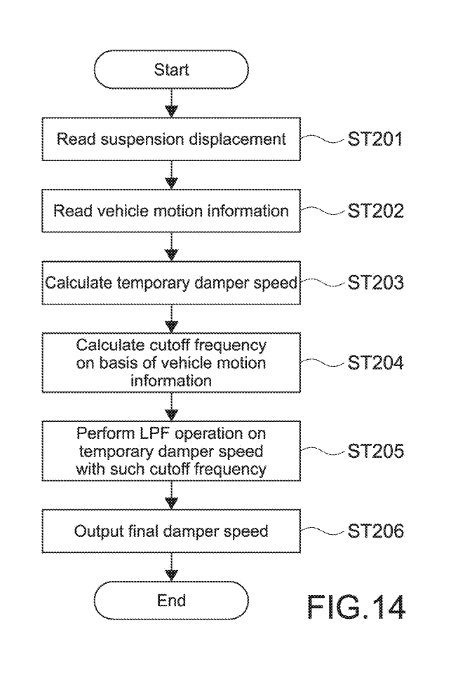

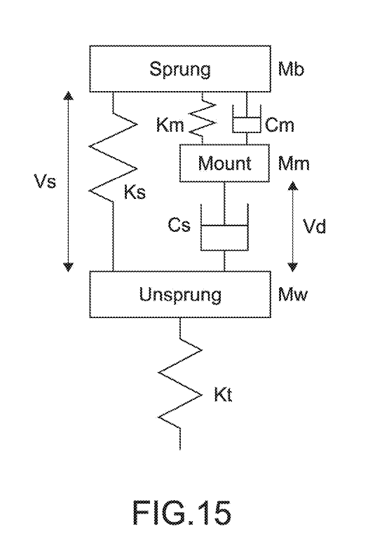

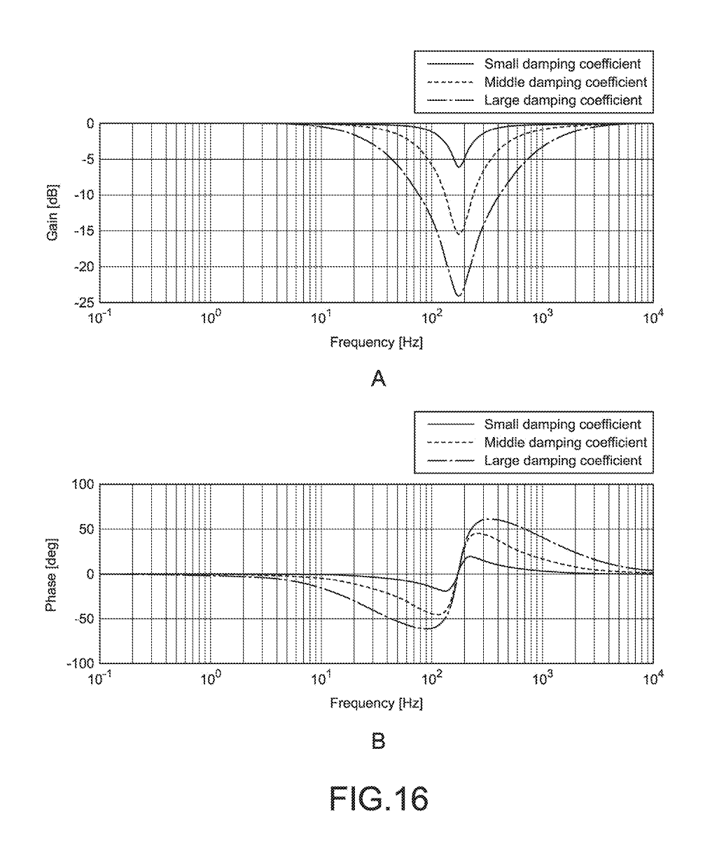

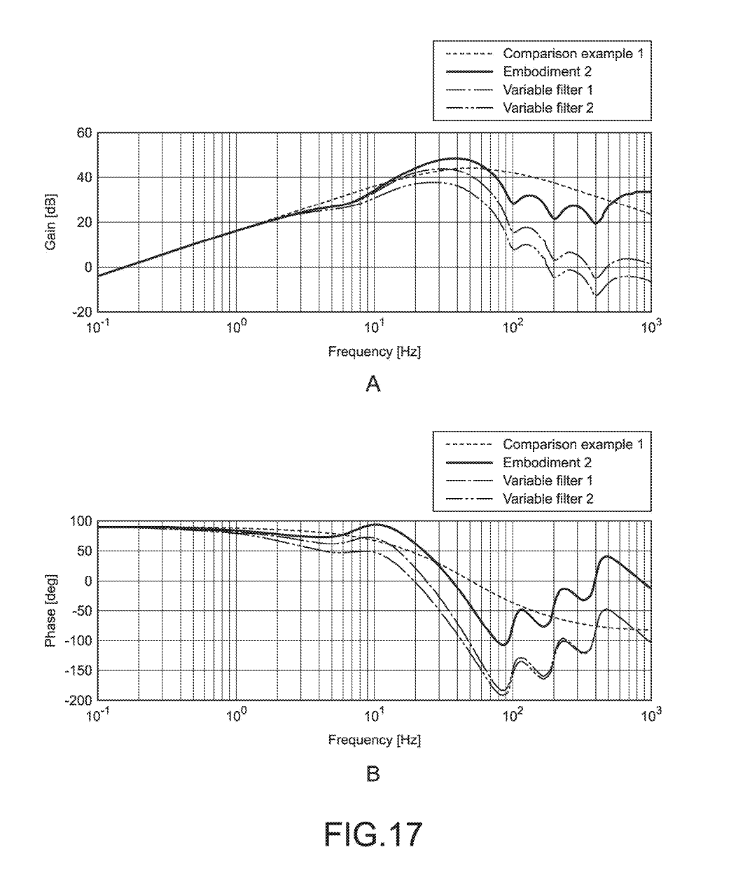

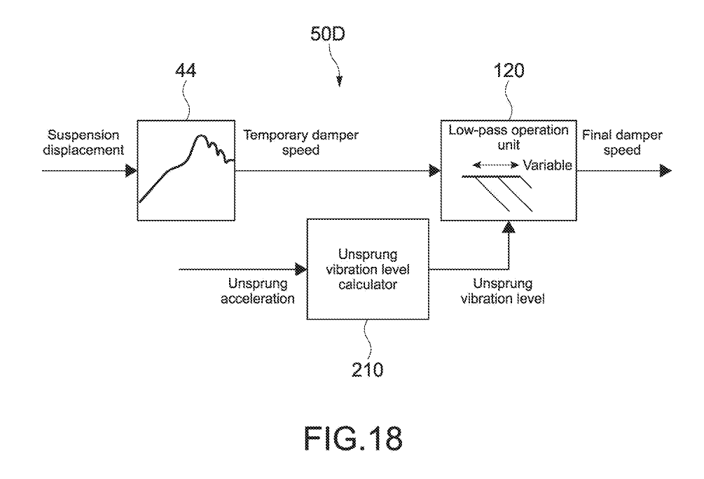

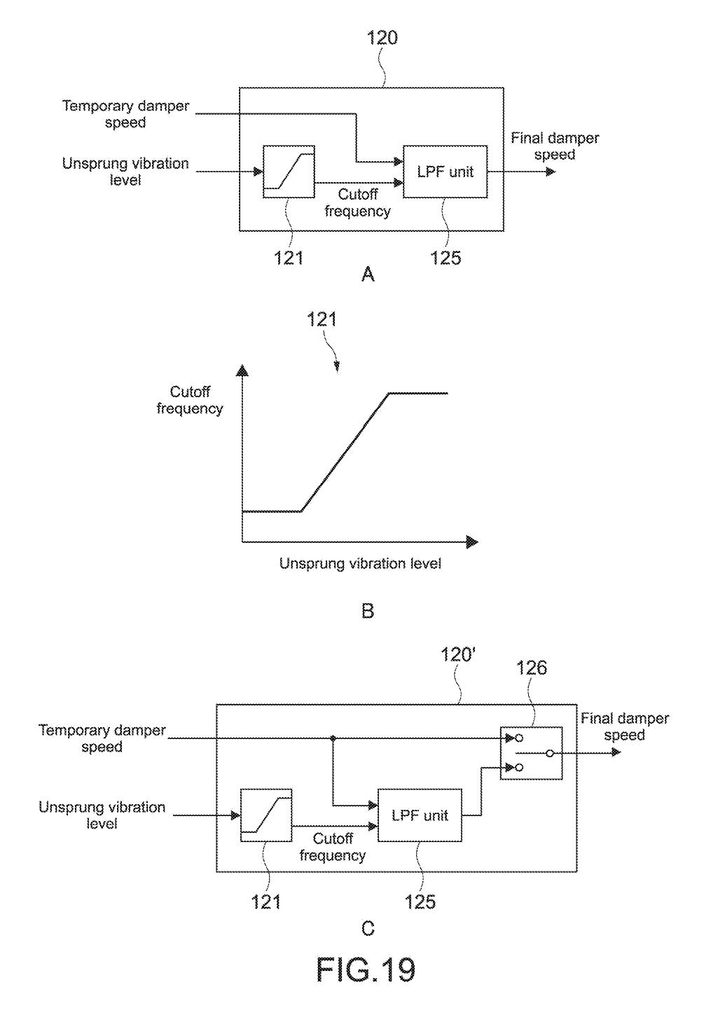

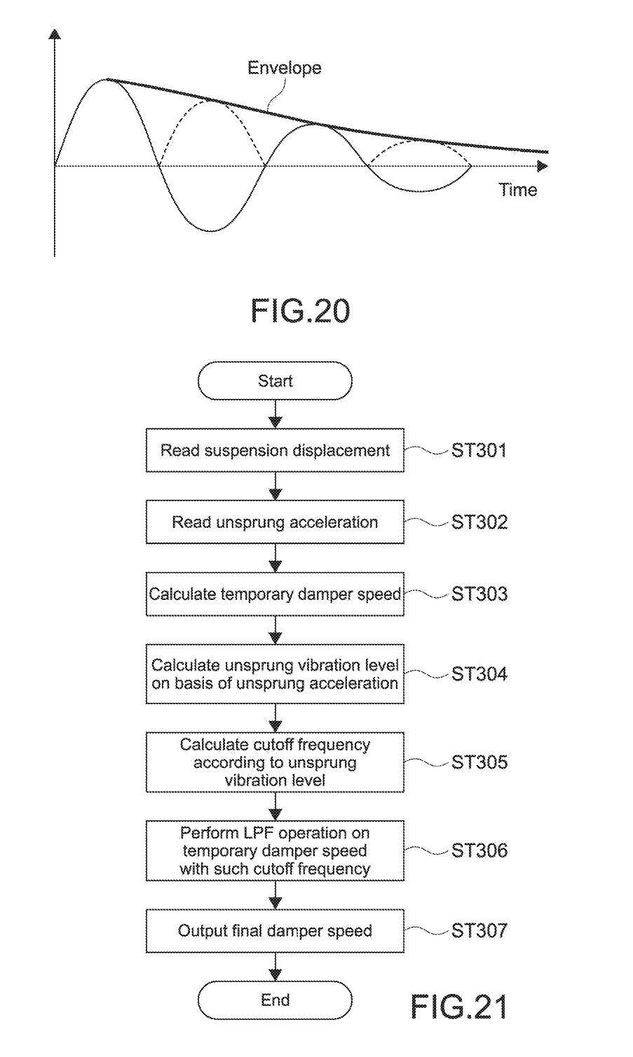

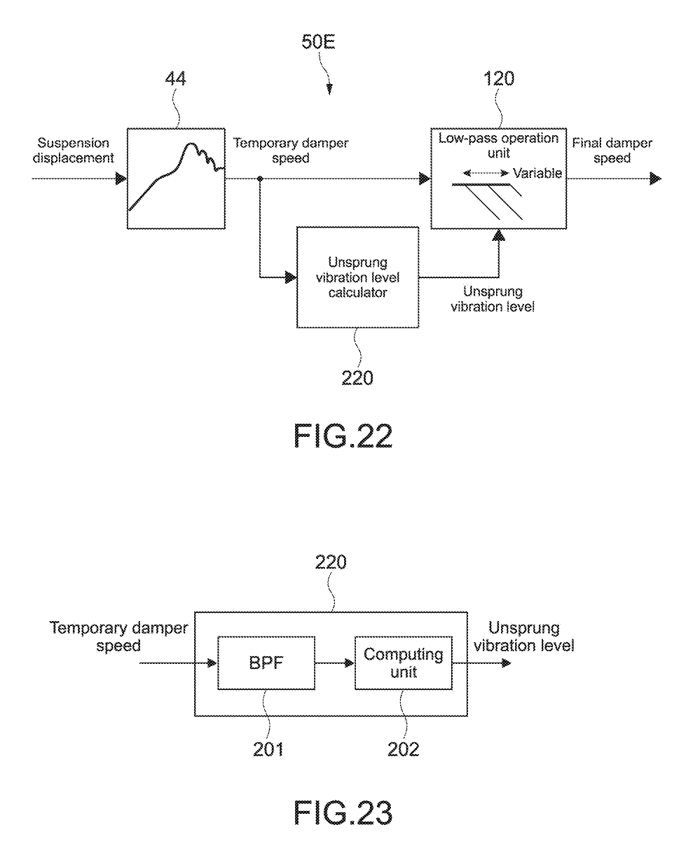

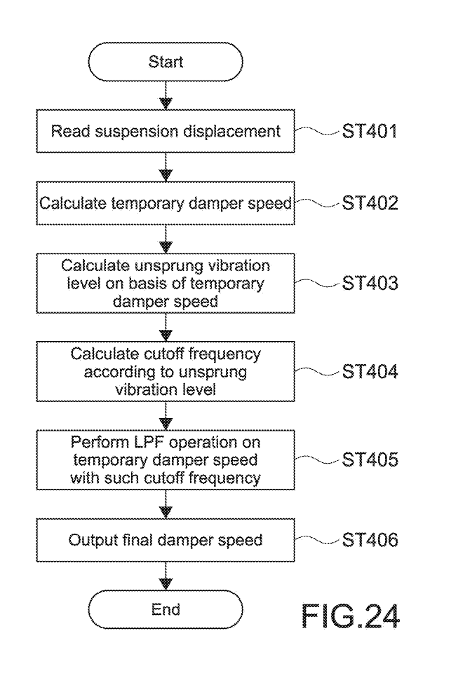

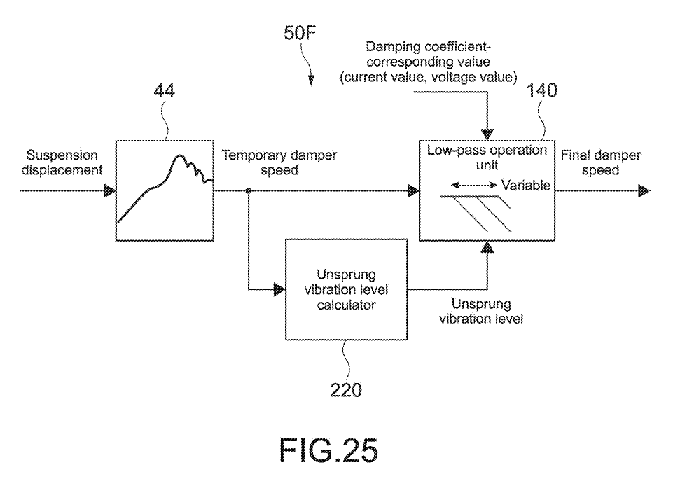

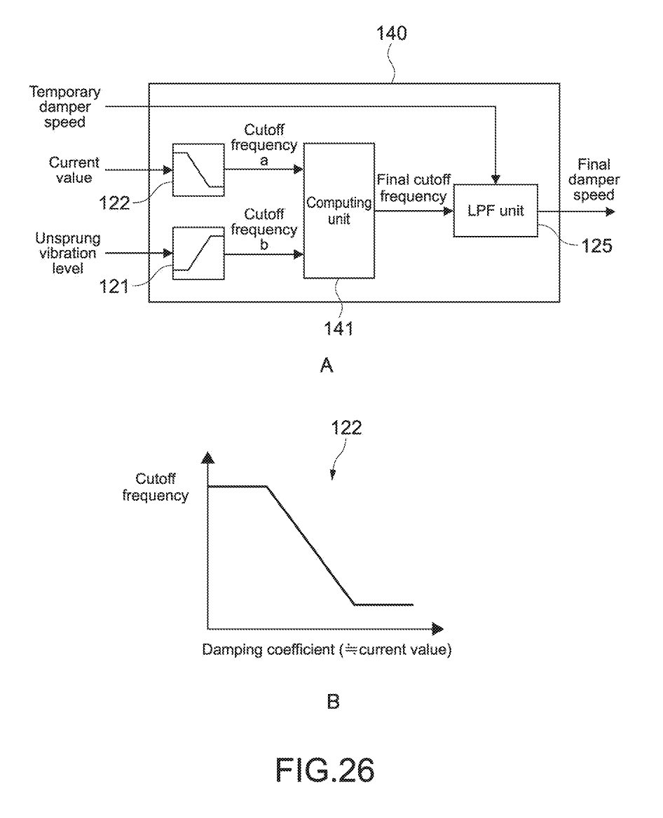

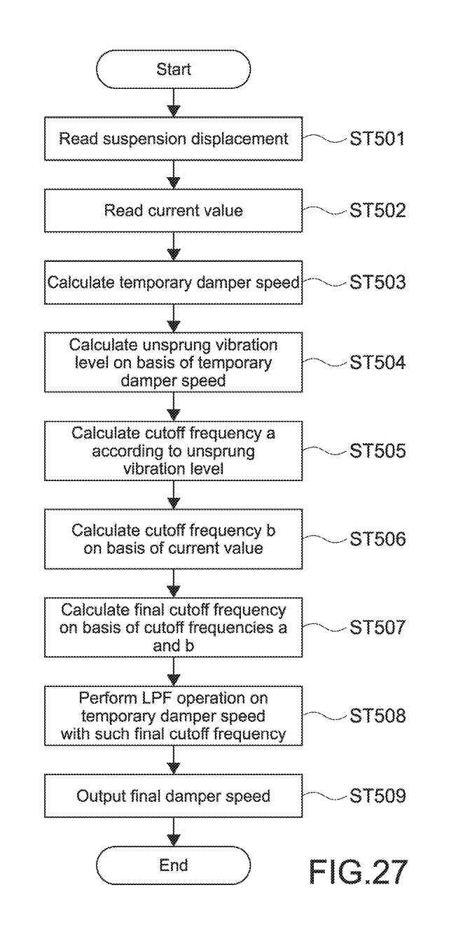

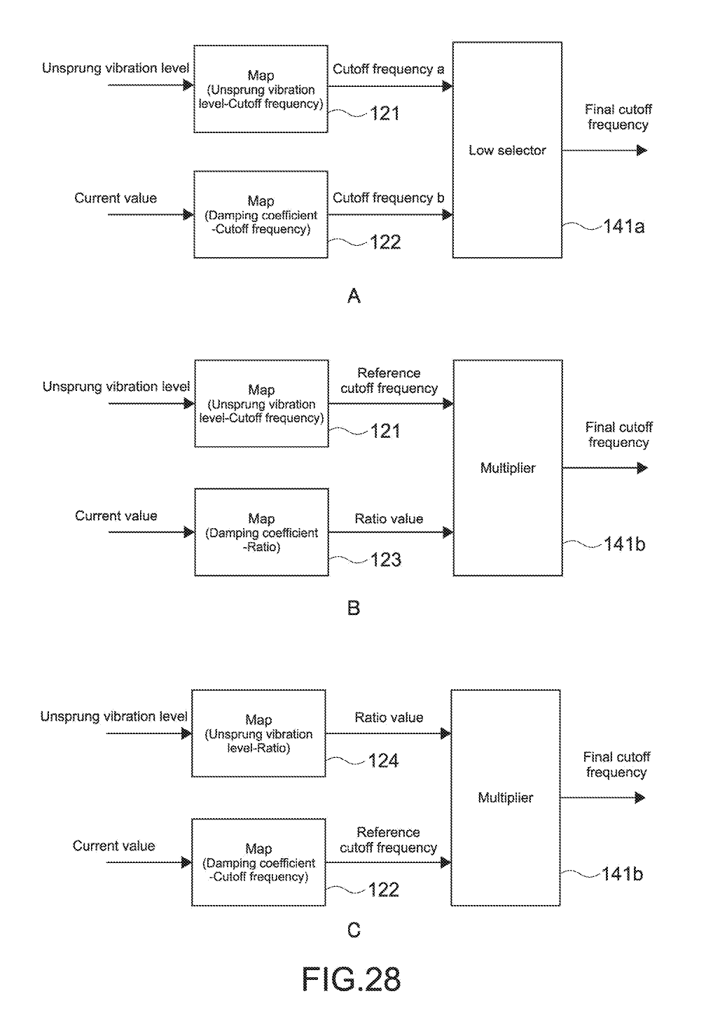

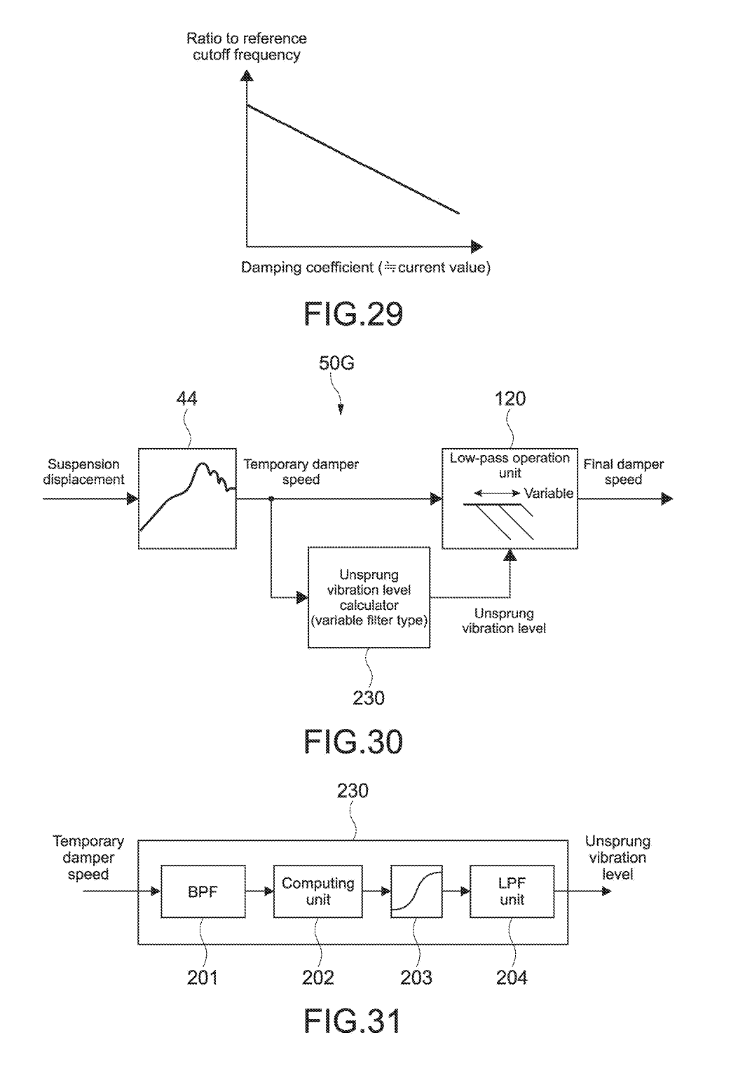

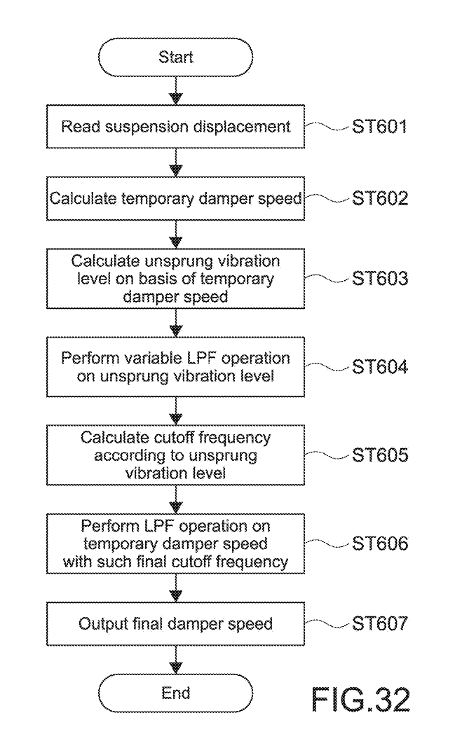

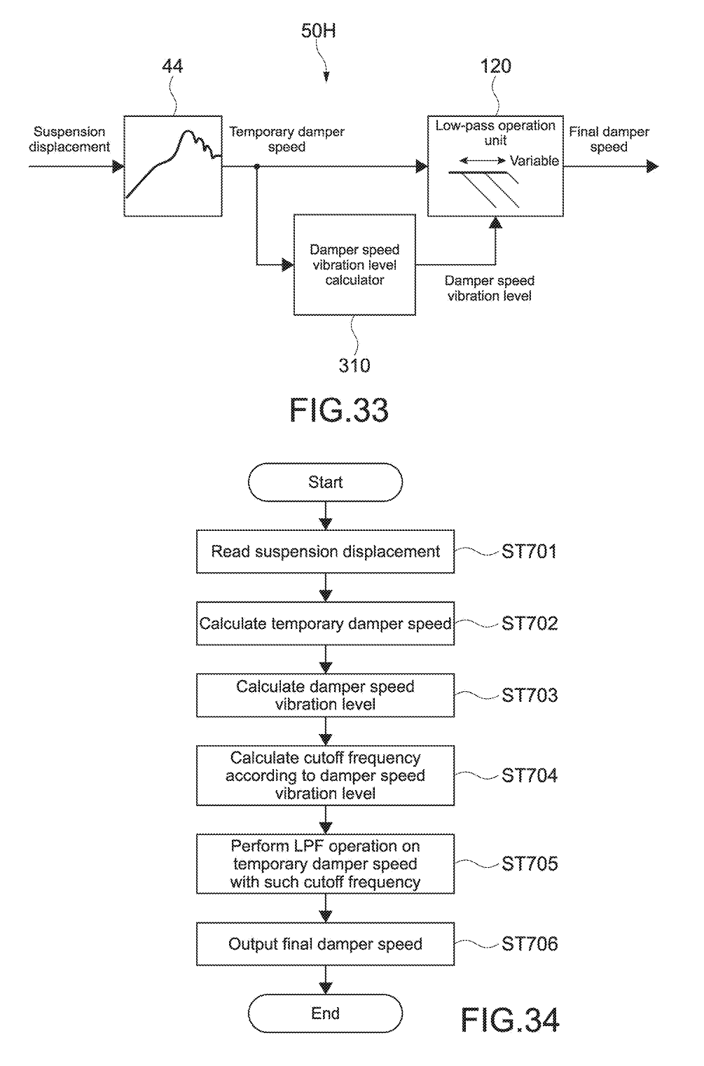

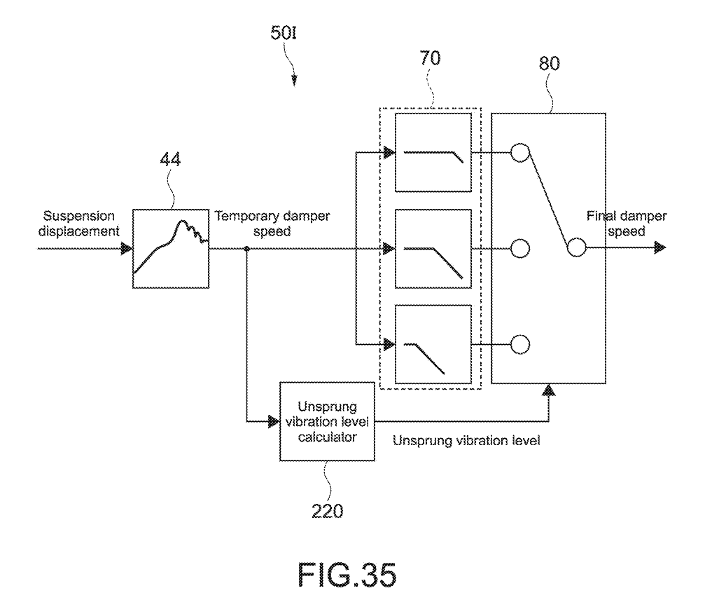

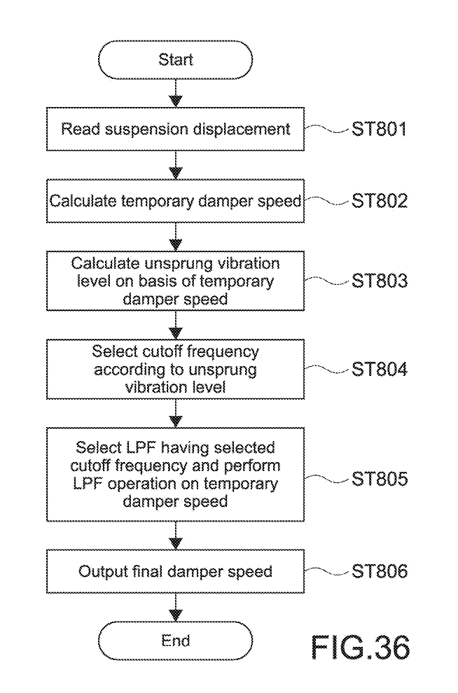

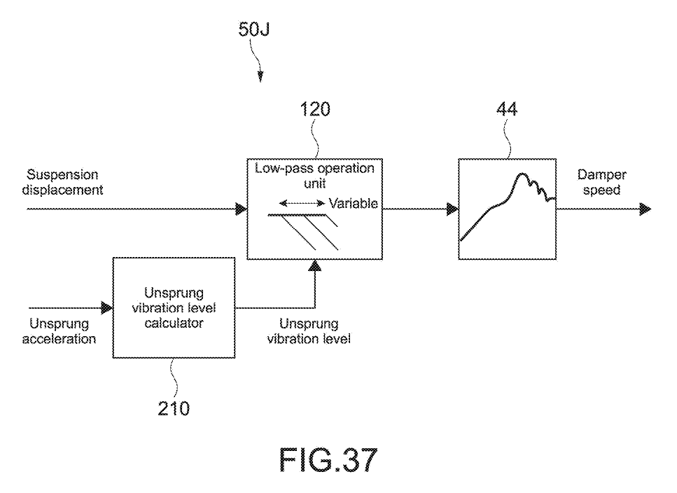

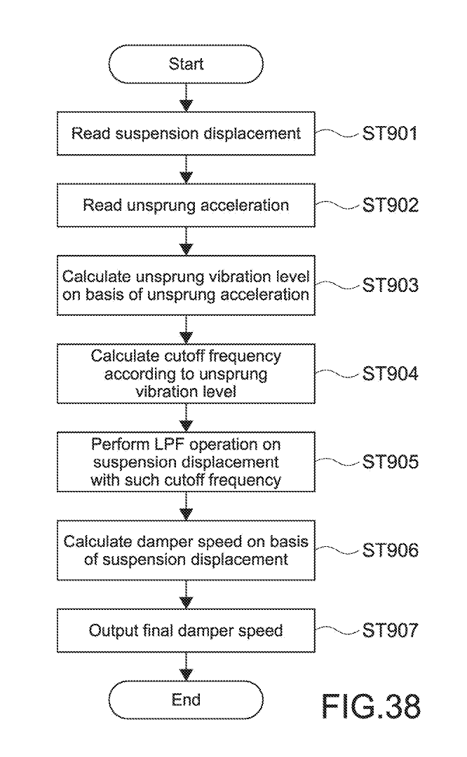

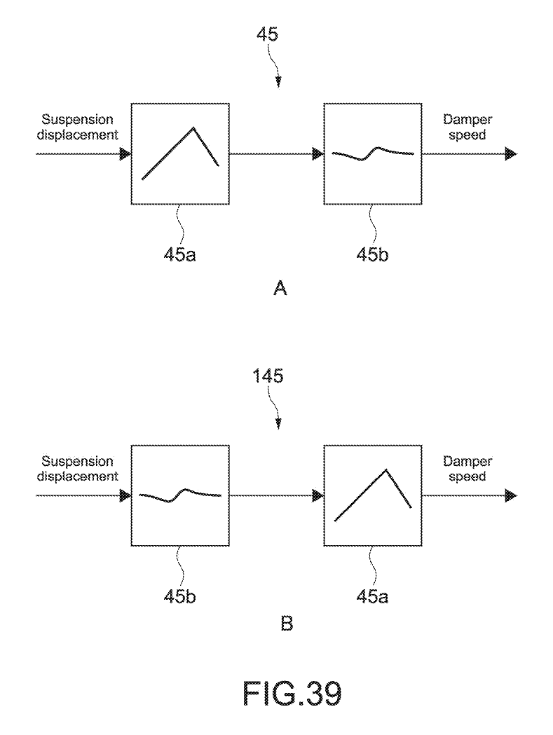

A and B of FIG. 6 show differential operating characteristics of the damper speed calculation unit shown in FIG. 5.

A and B of FIG. 7 respectively showing a gain characteristic and a phase characteristic as the differential operating characteristics according to Embodiment 2 shown in A and B of FIG. 6 are compared with Comparison Example 1.

A and B of FIG. 8 show an LPF characteristic that allows a low region to pass therethrough, a BPF characteristic that allows a middle region to pass therethrough, and a low and middle-combined filter characteristic generated by combining them.

A and B of FIG. 9 show filter characteristics generated by providing high-region BEF characteristics in series in the low and middle-combined filter characteristics in A and B of FIG. 8 and combining three low, middle, and high regions.

A and B of FIG. 10 show comparison of differential operating characteristic having high-region BEF characteristics with LPF characteristics according to Comparison Examples 2, 3, and 4.

A and B of FIG. 11 show differential operating characteristics in a damper speed calculation unit according to Embodiment 3.

FIG. 12 shows a differential operating characteristic of a damper speed calculation unit according to Embodiment 4.

FIG. 13 is a block diagram showing a configuration of a suspension displacement processor according to Embodiment 5.

FIG. 14 is a flowchart showing an operation of this suspension displacement processor.

FIG. 15 is an analysis model for considering a transfer characteristic from a suspension speed to a damper speed.

A and B of FIG. 16 show a gain characteristic and a phase characteristic that depend on the magnitude of a damper damping coefficient.

A and B of FIG. 17 show characteristics when LPFs each having a variable cutoff frequency are connected to a differential operation filter according to Embodiment 2 in series and the cutoff frequency is varied.

FIG. 18 is a block diagram showing a configuration of a suspension displacement processor according to Embodiment 6.

A of FIG. 19 is a block diagram showing a configuration of a low-pass operation unit shown in FIG. 18. B of FIG. 19 graphically shows an example of a map. C of FIG. 19 shows a low-pass operation unit according to a modified example of Embodiment 6.

FIG. 20 conceptually shows a vibration level.

FIG. 21 is a flowchart showing an operation of the suspension displacement processor according to Embodiment 6.

FIG. 22 is a block diagram showing a configuration of a suspension displacement processor according to Embodiment 7.

FIG. 23 is a block diagram showing a configuration of an unsprung vibration level calculator shown in FIG. 22.

FIG. 24 is a flowchart showing an operation of the suspension displacement processor according to Embodiment 7.

FIG. 25 is a block diagram showing a configuration of a suspension displacement processor according to Embodiment 8.

A of FIG. 26 is a block diagram showing a configuration of a low-pass operation unit shown in FIG. 25. B of FIG. 26 graphically shows an example of a map.

FIG. 27 is a flowchart showing an operation of a suspension displacement processor according to Embodiment 8.

A to C of FIG. 28 are diagrams for explaining computing examples of a computing unit 141 in a low-pass operation unit according to Embodiment 8.

FIG. 29 shows an example of a map in B of FIG. 28.

FIG. 30 is a block diagram showing a configuration of a suspension displacement processor according to Embodiment 9.

FIG. 31 is a block diagram showing a configuration of an unsprung vibration level calculator shown in FIG. 30.

FIG. 32 is a flowchart showing an operation of a suspension displacement processor according to Embodiment 9.

FIG. 33 is a block diagram showing a configuration of a suspension displacement processor according to Embodiment 10.

FIG. 34 is a flowchart showing an operation of the suspension displacement processor according to Embodiment 10.

FIG. 35 is a block diagram showing a configuration of a suspension displacement processor according to Embodiment 11.

FIG. 36 is a flowchart showing an operation of the suspension displacement processor according to Embodiment 11.

FIG. 37 is a block diagram showing a configuration of a suspension displacement processor according to Embodiment 12.

FIG. 38 is a flowchart showing an operation of the suspension displacement processor according to Embodiment 12.

A and B of FIG. 39 are block diagrams each showing a configuration of a damper speed calculation unit according to Embodiment 13.

### MODE(S) FOR CARRYING OUT THE INVENTION

Hereinafter, embodiments according to the present invention will be described with reference to the drawings.

[Suspension Control System]

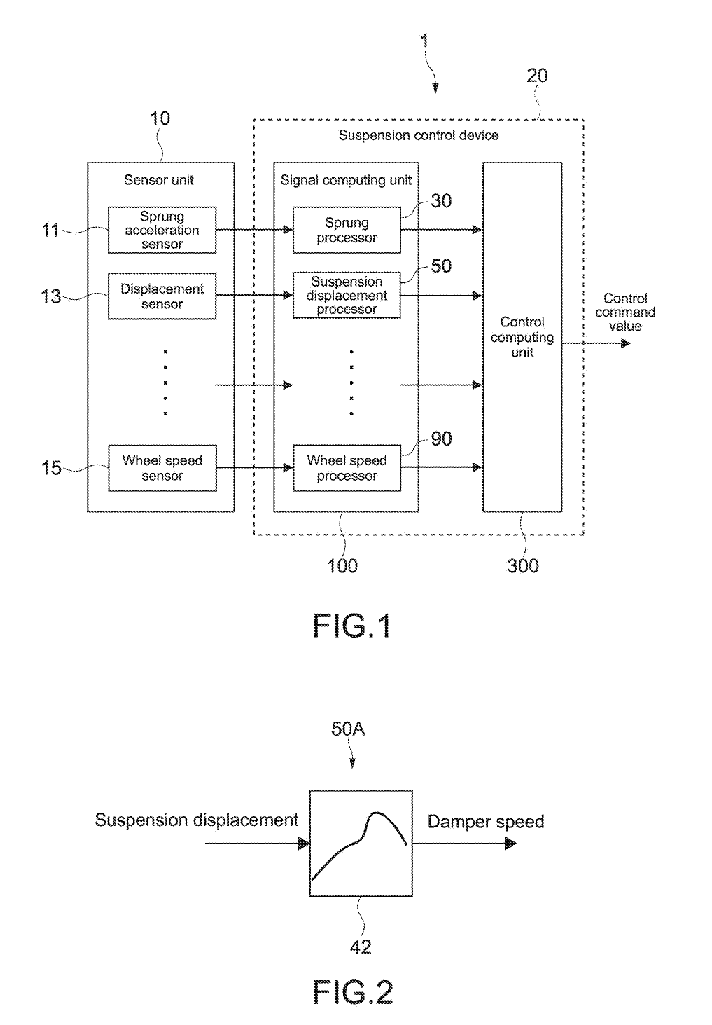

FIG. 1 is a block diagram showing a suspension control system according to an embodiment of the present invention. This suspension control system 1 can be used for a vehicle, typically a four-wheel vehicle. The suspension control system 1 includes a sensor unit 10 and a suspension control device 20. The sensor unit 10 includes a plurality of sensors. The suspension control device 20 controls movements of a suspension (not shown) on the basis of various detection values from the sensor unit 10.

The sensor unit 10 includes various sensors that provide information about behaviors of the vehicle. The various sensors are, for example, a sprung acceleration sensor 11, a displacement sensor 13, and a wheel speed sensor 15.

The sprung acceleration sensor 11 is mounted on a vehicle body (e.g., chassis), for example, to detect sprung acceleration. The displacement sensor 13, which is also called vehicle height sensor, is mounted on the vehicle body or a suspension arm, for example, to detect a relative displacement therebetween, that is, a relative displacement between the sprung and unsprung portions. In the following description, the relative displacement between the sprung and unsprung portions will be referred to as a suspension displacement. The wheel speed sensor 15 detects a wheel speed and is mounted on a wheel hub, for example.

Note that the sensor unit 10 may also include, in addition to the sprung acceleration sensor 11, the displacement sensor 13, and the wheel speed sensor 15, an unsprung acceleration sensor, a steering angle sensor, and the like.

Those sensors are merely examples and their specifications can differ depending on the type of vehicle. Further, the number of sensors is appropriately set depending on the type of vehicle and the like. For example, displacement sensors 13 may be mounted on only two of four wheels or one or more sprung acceleration sensors 11 may be provided.

Further, all the above-mentioned sensors are not necessarily mounted on a vehicle. For example, either one of the unsprung acceleration sensor and the displacement sensor 13 is mounted on a vehicle in many case. For example, as shown in the example of FIG. 1, the suspension control system includes the displacement sensor 13 without the unsprung acceleration sensor.

[Suspension Control Device]

The suspension control device 20 includes a signal computing unit 100 and a control computing unit 300.

The signal computing unit 100 receives detection values of the various sensors, which are output from the sensor unit 10, and processes and computes the detection values to generate information necessary for computing of the control computing unit 300. The signal computing unit 100 according to this embodiment includes a suspension displacement processor (signal processing device) 50 that acquires, in particular, a suspension displacement from the displacement sensor 13. As will be described later, the suspension displacement processor 50 calculates a damper speed, an unsprung vibration level, a damper speed vibration level, a damper speed change ratio, and the like on the basis of the suspension displacement, for example.

In the current state, no sensors that directly calculate damper displacement and a damper speed exist. Therefore, as will be described later, the suspension displacement processor 50 estimates a damper speed by differentiating a suspension displacement output from the displacement sensor 13 and outputs it.

Note that, in addition to the suspension displacement processor 50, the signal computing unit 100 includes a sprung processor 30, a wheel speed processor 90, and the like. The sprung processor 30 calculates, on the basis of a detection value from the sprung acceleration sensor 11, a sprung speed, a sprung vibration level, a bounce speed, a pitch speed, a roll speed, and the like. The wheel speed processor 90 processes a wheel speed from the wheel speed sensor 15 and outputs the wheel speed and information about it. Further, although not shown in the figure, the signal computing unit 100 further includes a steering speed calculation unit, a computing unit, and the like. The steering speed calculation unit calculates a steering speed on the basis of a detection value from the steering angle sensor. The computing unit acquires lateral acceleration and outputs a differential value (lateral speed) of the lateral acceleration.

The suspension control device 20 may include a distribution unit that distributes various other types of vehicle behavior information, for example, the above-mentioned damper speed obtained by the signal computing unit 100, into computing units (not shown) provided in the control computing unit 300.

On the basis of the various types of vehicle behavior information received from the signal computing unit 100, the control computing unit 300 performs computing, generates a control command, and outputs it to a damper (not shown) provided between the vehicle body and an axle. As a matter particularly relating to the present technology, the control computing unit 300 reads a damper speed and the like obtained from the suspension displacement processor 50 and generates a control command value on the basis of a damping characteristic relating to the damper speed, which will be described later.

It should be noted that the “damping force” is different from the “damping characteristic (or damping coefficient)”. The damping characteristic means characteristics per se indicating a relationship between the damper speed and the damping force. The “variable damping characteristic” means that the relationship is present with a plurality of stages or without any stages. On the other hand, the “damping characteristic” and the “damping coefficient” are substantially synonymous. It should be noted that, strictly speaking, the damping characteristic is the relationship (characteristic) per se between the damper speed and the damping force and the damping coefficient expresses the damping characteristic in numerical form, and hence the both are different from each other.

Note that the control computing unit 300 is configured to calculate, on the basis of the various types of vehicle behavior information received from the signal computing unit 100, a plurality of control command values for reduction of roll, pitch, and sprung resonance, steering stabilization, and the like, and to output one of the control command values by processing such as high select and smoothing high select. It is not limited to the high select and the like, low select processing or averaging processing may be performed.

For example, a damper of a damping force (strictly speaking, damping characteristic or damping coefficient) variable type can be employed as the damper. The damping characteristic varies when the control command value output from the control computing unit 300, for example, a current value or a voltage value is input into the damper of the damping characteristic variable type. The damper of the damping coefficient variable type includes, for example, a magnetic viscous fluid system, a proportional solenoid system, and an electroviscous fluid system. With the magnetic viscous fluid system and the proportional solenoid system, the control command value is a current value. With the electroviscous fluid system, the control command value is a voltage value. Therefore, the term “current value” shown below can be replaced by the “voltage value”.

Note that, although not shown in the figure, the suspension control device 20 can be realized by hardware elements used for a computer, a CPU (Central Processing Unit), a RAM (Random Access Memory), a ROM (Read Only Memory), and necessary software. Instead of or in addition to the CPU, a PLD (Programmable Logic Device) such as an FPGA (Field Programmable Gate Array) or a DSP (Digital Signal Processor) or the like may be used.

[Suspension Displacement Processor]

Hereinafter, various embodiments of the suspension displacement processor 50 will be described. Note that “suspension displacement processors” according to Embodiments 1, 2, and 5 to 12 below are respectively denoted by symbols 50A, 50B, 50C, 50D, 50E, 50F, 50G, 50H, 50I, and 50J.

### Embodiment 1

FIG. 2 is a block diagram showing a configuration of a suspension displacement processor 50A according to Embodiment 1. The suspension displacement processor 50A includes a damper speed calculation unit 42. The damper speed calculation unit 42 acquires information on a suspension displacement from the displacement sensor 13, differentiates it, and outputs a damper speed.

A and B of FIG. 3 show bode plots that are differential operating characteristics of the damper speed calculation unit 42. A of FIG. 3 shows a gain characteristic and B of FIG. 3 shows a phase characteristic, each of which shows comparison with an exact differential. In the figure, a characteristic of Embodiment 1 is shown by the solid line and a characteristic of the exact differential is shown by the broken line.

When the gain characteristic of the exact differential is used as it is, noise is generated in a high-frequency region (e.g., region higher in frequency than unsprung resonance frequency region). Therefore, it is necessary to perform LPF (Low Pass Filter) processing for removing the high-frequency noise. However, there is a problem in that a phase in the unsprung resonance frequency region is delayed due to the LPF processing.

In view of this, as shown in A of FIG. 3, the differential operating characteristic (differential filter) includes a gain characteristic having a gradient larger than a gradient of the gain characteristic of the exact differential in the unsprung resonance frequency region. The unsprung resonance frequency region is approximately 10 Hz to 20 Hz. It is assumed that the unsprung resonance frequency according to this example is 12 Hz. Further, this differential operating characteristic includes an LPF characteristic in order to reduce noise in the region higher in frequency than the unsprung resonance frequency region as described above. Therefore, as shown in A and B of FIG. 3, the differential operating characteristic has a characteristic of being substantially downward to the right in the high-frequency region.

The differential operating characteristic includes the gain characteristic of the gradient larger than the gradient of the gain characteristic of the exact differential in the unsprung resonance frequency region as described above. Therefore, as shown in B of FIG. 3, the phase delay in the unsprung resonance frequency region is compensated. Regarding a phase characteristic according to this example, the phase is 90 deg at 12 Hz, which is equal to the phase of the exact differential. In other words, the original phase characteristic of the damper speed can be obtained. In Embodiment 1, even with the differential operating characteristic including the LPF characteristic as a countermeasure against the high-frequency noise, the problem of the phase delay can be overcome and control performance provided when performing vehicle control using the damper speed information is enhanced.

Further, this differential operating characteristic further includes a gain characteristic having a gradient smaller than the gradient of the gain characteristic of the exact differential in a frequency region between the sprung resonance frequency region and the unsprung resonance frequency region. The sprung resonance frequency region is approximately 1 Hz to 2 Hz and roughly 0.5 Hz to 3 Hz. The gradient of the gain is thus smaller the region lower in frequency than the unsprung resonance frequency region and the gradient is larger in the unsprung resonance frequency region as described above. Thus, as shown in B of FIG. 3, the phase is compensated to be a value (about 90 deg) nearly equal to the exact-differential characteristic in the unsprung resonance frequency region (the unsprung resonance frequency is 12 Hz in this example). With this, the phase in the unsprung resonance frequency region can be closer to the original phase of the damper speed.

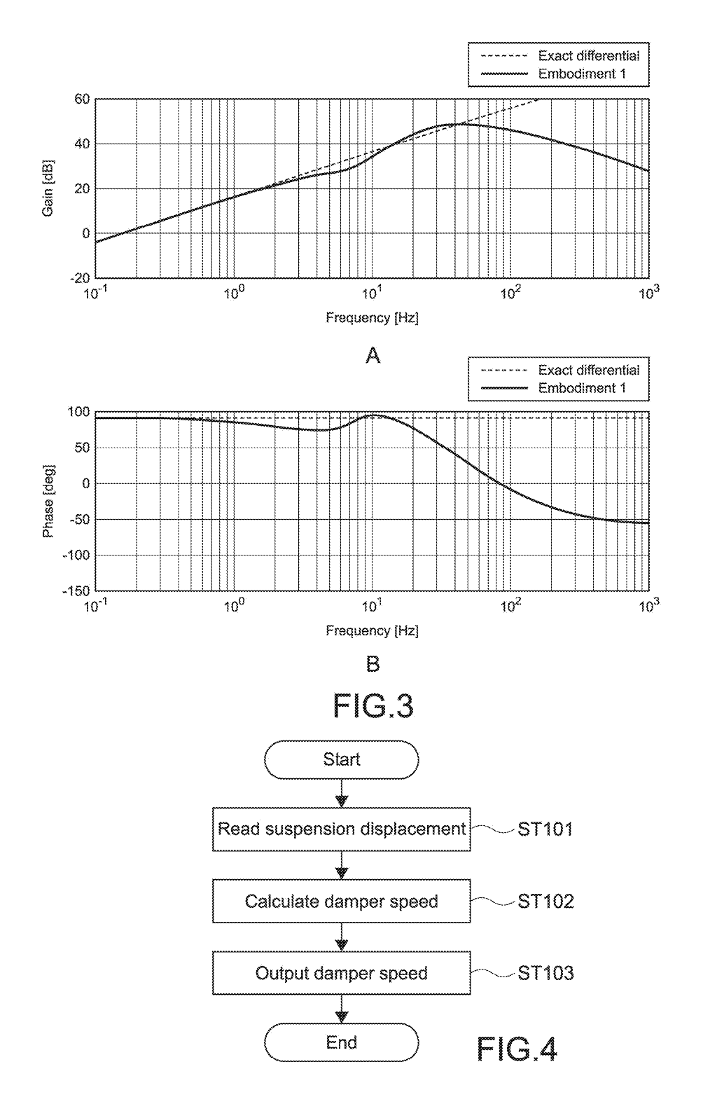

FIG. 4 is a flowchart showing an operation of the suspension displacement processor 50A. The damper speed calculation unit 42 reads a suspension displacement (Step 101), performs a differential operation on it using the differential operating characteristic shown in A and B of FIG. 3 (Step 102), and outputs a damper speed (Step 103).

### Embodiment 2

FIG. 5 shows another example of the damper speed calculation unit as a configuration of a suspension displacement processor according to Embodiment 2. Hereinafter, elements substantially similar to functions and the like of the suspension displacement processor 50A according to Embodiment 1 above will be denoted by identical symbols and descriptions thereof will be simplified or omitted and different points will be mainly described.

A and B of FIG. 6 show differential operating characteristics of this damper speed calculation unit 44. In the figure, a characteristic of Embodiment 2 is shown by the solid line and a characteristic of the exact differential is shown by the broken line. A different point between these differential operating characteristics and the differential operating characteristics of A and B of FIG. 3 is in that a BEF (Band Elimination Filter) characteristic, that is, a characteristic of a notch filter is provided in the region higher in frequency than the unsprung resonance frequency region. A gain in a predetermined region of this high-frequency region is reduced by BEF processing. Embodiment 2 includes BEF characteristics arranged in series at respective frequencies in the region of 100 Hz to 400 Hz, for example. For example, those frequencies are 100 Hz, 200 Hz, and 400 Hz.

Note that the region of 100 Hz to 400 Hz that is the high-frequency region whose noise is removed is merely an example and this region may be appropriately changed.

It is conceivable that a continuous high-frequency region of 100 Hz to 400 Hz is removed by the LPF processing. However, the gain can be reduced in the high-frequency region while a phase delay occurs in the unsprung resonance frequency region. The decrease in gain in the high-frequency region and the phase delay in the unsprung resonance frequency region are intrinsically in a conflicting relationship. In Embodiment 2, for the purpose of reducing the gain in the high-frequency region as much as possible and reduce such a phase delay as much as possible at the same time, this differential operating characteristic includes the plurality of BEF characteristics arranged in series.

A and B of FIG. 7 respectively show a gain characteristic and a phase characteristic as the differential operating characteristics according to Embodiment 2 shown in A and B of FIG. 6 are compared with Comparison Example 1. In the figure, a characteristic of Embodiment 2 is shown by the solid line and a characteristic of Comparison Example 1 is shown by the alternate long and short dash line. Comparison Example 1 shows an example in which merely BPF (Band Pass Filter) characteristics that perform second-order LPF processing in series are provided with respect to the exact-differential characteristic.

Regarding the phase characteristic of Comparison Example 1, it can be seen that a phase delay occurs in or near the unsprung resonance frequency region due to the influence of the LPF processing. In contrast, it can be seen that, in accordance with the differential operating characteristics according to Embodiment 2, the phase delay in the unsprung resonance frequency region is compensated in comparison with Comparison Example 1, and that the gain can be greatly lowered in the noise-removed region of 100 Hz to 400 Hz.

(Design Procedure for Differential Operating Characteristic)

Here, a design procedure for the differential operating characteristic will be described. Embodiment 2 shown in FIG. 6 will be exemplified as the differential operating characteristic.

A and B of FIG. 8 are bode plots each showing an LPF characteristic for a low region, a BPF characteristic for a middle region, and a low and middle-combined filter characteristic generated by combining them. A key point for designing the low and middle-combined filter characteristic is in that the gain is approximately 0 dB in the unsprung resonance frequency (here, for example, approximately 12 Hz) and that it is set to a characteristic such that the phase is advanced to 0 deg or more in the unsprung resonance frequency region in view of the phase delay due to the additional insertion of the BEFs in the high region as described above.

Further, with respect to the sprung resonance frequency region (1 Hz to 2 Hz) of the low-region LPF characteristic, the transfer-function order of the LPF is set to be a second order in order to increase a drop at approximately 8 Hz of the gain of the low and middle-combined filter characteristic. Further, a drop in the high region of the BPF is also set to have a second-order gradient. Note that that in the low region of the BPF is set to be a first-order gradient.

A and B of FIG. 9 each show a filter characteristic generated by providing high-region BEF characteristics in series in the low and middle-combined filter characteristic, which is generated by combining the low region and the middle region as described above, and combining the three low, middle, and high regions. In the figure, the filter characteristic generated by combining the three low, middle, and high regions is shown by the solid line. Note that, in FIG. 9, in order to make it easy to see the graph and design the filter characteristics, a process of integrating data to be plane again is performed. The gain and the phase are respectively set to 0 dB and 0 deg by integration.

Here, a key point is in that the gain is about 0 dB and the phase is about 0 deg in the unsprung resonance frequency region. If impossible to achieve it, returning to designing of FIG. 8, designing of FIGS. 8 and 9 is repeated. The thus obtained filter characteristic that is a combination of the low, middle, and high regions becomes the differential operating characteristic according to Embodiment 2 shown in FIG. 6.

A and B of FIG. 10 are bode plots each showing comparison of the differential operating characteristic including the high-region BEF characteristics with the differential operating characteristic including the LPF characteristic according to Comparison Example 2, 3, or 4 as a countermeasure for removing noise removal in the region of 100 Hz to 400 Hz. In the figure, the differential operating characteristic including the high-region BEF characteristics is shown by the solid line.

Although Comparison Example 2 is a characteristic into which a first-order LPF has been inserted, the gain reduction in a noise band that is the region of 100 Hz to 400 Hz becomes a problem. Although Comparison Example 3 is a characteristic into which a second-order LPF has been inserted and the compensation for the phase delay in the unsprung resonance frequency region is equivalent to that of the differential operating characteristic including the high-region BEF characteristics, the gain reduction at approximately 100 Hz becomes a problem. Although Comparison Example 4 is a characteristic into which a third-order LPF has been inserted and has an a noise reduction effect equal to or larger than that of the differential operating characteristic including the high-region BEF characteristics in the noise band, the phase delay in the unsprung resonance frequency region becomes a problem.

In contrast, the differential operating characteristic including the high-region BEF characteristics can solve the problem of the both of the gain reduction in the noise band and the phase delay in the unsprung resonance frequency region, which are in the conflicting relationship as described above.

### Embodiment 3

A and B of FIG. 11 show differential operating characteristics of a damper speed calculation unit in a suspension displacement processor according to Embodiment 3. In A and B of FIG. 11, the differential operating characteristics according to Embodiment 2 are shown as comparison. In the figure, a characteristic of Embodiment 3 is shown by the solid line and the characteristic of Embodiment 2 is shown by the broken line. The differential operating characteristic according to Embodiment 3 further includes HPF (High Pass Filter) characteristics having a cutoff frequency lower than that of the sprung resonance frequency region. With this, as shown in B of FIG. 11, the phase of the sprung resonance frequency region (i.e., 1 Hz to 2 Hz, and roughly 0.5 Hz to 3 Hz, for example) can be closer to the phase characteristic of the exact differential in the same frequency region. In other words, the phase characteristic having the original phase of the damper speed can be obtained in the sprung resonance frequency region.

### Embodiment 4

FIG. 12 shows a differential operating characteristic of a damper speed calculation unit in a suspension displacement processor according to Embodiment 4. This differential operating characteristic includes a gain characteristic of a gradient having a gradient of the gain characteristic of the exact differential in the unsprung resonance frequency region. In accordance with such a characteristic, the phase delay in the unsprung resonance frequency region can be compensated. It should be noted that the gain in the unsprung resonance frequency region becomes larger than the gain of the exact differential.

### Embodiment 5

FIG. 13 is a block diagram showing a configuration of a suspension displacement processor according to Embodiment 5. This suspension displacement processor 50C includes the damper speed calculation unit 44 shown in Embodiment 2 or 3 above (that may be Embodiment 1) and a low-pass operation unit 110. Information on a damper speed output from this damper speed calculation unit 44 is input into the low-pass operation unit 110. The low-pass operation unit 110 reads vehicle motion information and includes a cutoff frequency variable according to this vehicle motion information.

The vehicle motion information means various types of information such as a suspension displacement, a damper speed, sprung acceleration, a wheel speed, a steering angle, lateral acceleration, a current value, a voltage value, and information (e.g., vibration level to be described later) obtained by processing at least one of those values.

The current value and the voltage value are a current value and a voltage value that are the control command values output to the damper as described above, or an actual current value and an actual voltage value that are actually detected by sensors in the damper.

FIG. 14 is a flowchart showing an operation of this suspension displacement processor 50C. The damper speed calculation unit 44 reads a suspension displacement (Step 201), and the low-pass operation unit 110 reads vehicle motion information (Step 202). The damper speed calculation unit 44 calculates a temporary damper speed (Step 203), and the low-pass operation unit 110 calculates a cutoff frequency according to the vehicle motion information (Step 204). The low-pass operation unit 110 performs an LPF operation on the input temporary damper speed with the calculated cutoff frequency (Step 205), and outputs a final damper speed (Step 206). Hereinafter, this damper speed output from the suspension displacement processor 50C will be referred to as a “final damper speed”.

Due to such a low-pass operation unit 110, noise components contained in the damper speed can be removed. Further, the cutoff frequency is variable, and hence, whether to prioritize estimation accuracy for the damper speed (to increase the cutoff frequency) or to prioritize noise removal (to lower the cutoff frequency) can be adaptively selected according to the vehicle motion information. With this, the control performance is enhanced.

Note that the term “estimation accuracy” for the damper speed is an output accuracy for a final damper speed of the suspension displacement processor 50C.

(Regarding Transfer Characteristic from Suspension Speed to Damper Speed)

In the above-mentioned concept, the suspension displacement processor 50C is configured on the premise that the differential value of the suspension displacement is considered as the damper speed. However, in order to estimate the damper speed with higher accuracy, it is necessary to consider the suspension speed that is the differential value of the suspension displacement as being, strictly speaking, different from the original damper speed. Therefore, estimating the damper speed with higher accuracy in view of a transfer characteristic from the suspension speed to the damper speed will be considered hereinafter.

FIG. 15 is an analysis model for considering the transfer characteristic from the suspension speed to the damper speed. Meanings of the symbols in the figure are as follows.
Mb: sprung mass
Mw: unsprung mass
Vs: suspension speed
Ks: spring constant of suspension including damper
Cs: damper damping coefficient
Vd: damper speed
Mm: damper rod mass (e.g., mass of damper rod, etc.)
Km: mount spring constant (spring constant of rubber bush mounted on mounting portion between damper and vehicle body)
Cm: mount damping coefficient (damping coefficient of such rubber bush, etc.)
Kt: tire spring constant

That is, the transfer characteristic from the suspension speed Vs to the damper speed Vd does not include the sprung mass Mb, the unsprung mass Mw, and the tire spring constant Kt transfer characteristic. However, those symbols are shown in FIG. 15 for the sake of easy understanding of the description.

Here, the transfer characteristic from Vs to Vd is expressed by the following expression.

$$\begin{matrix}[ Expression 1 ] & \\ \frac{{V}_{d}}{{V}_{s}} = \frac{{M}_{m} {s}^{2} + {C}_{m} s + {K}_{m}}{{M}_{m} {s}^{2} + ( {C}_{m} + {C}_{s} ) s + {K}_{m}} & ( 1 )\end{matrix}$$

Where “s” indicates a Laplace operator used in Laplace transformation.

In Expression (1), the transfer characteristic changes according to the magnitude of the damper damping coefficient (hereinafter, simply referred to as damping coefficient) Cs as shown in A and B of FIG. 16. A frequency at which a gain drop occurs is a resonance frequency constituted of the mount spring constant Km and the damper rod mass Mm. Note that, although it may be generally called resonance frequency of the mount, it is not a technically precise expression. Strictly speaking, the frequency called resonance frequency of the mount refers to a vibration frequency (frequency in the region in which the gain drop occurs) as described above.

Here, we will focus on the unsprung resonance frequency (12 Hz in this example) in the unsprung resonance frequency region. As the damping coefficient becomes smaller (as the damper becomes softer), the suspension speed Vs and the damper speed Vd becomes closer to each other (Vs=Vd). That is, in this case, the differential value of the suspension displacement is a value close to the damper speed as it is.

However, as the damping coefficient becomes larger (as the damper becomes harder), the offset of the phases of the both becomes larger and the gain becomes smaller as shown in A of FIG. 16. Thus, the percentage of displacement of the mount increases in proportion to this. In this manner, as the damping coefficient becomes larger, the phase of the damper is delayed (see B of FIG. 16) in the unsprung resonance frequency region. The gain is also reduced and it becomes more difficult for the damper to move.

Therefore, the low-pass operation unit 110 according to Embodiment 5 above uses the “damping coefficient” as the vehicle motion information and changes the cutoff frequency according to this damping coefficient, such that the damper speed can be estimated with higher accuracy.

Next, a merit obtained when the low-pass operation unit 110 according to Embodiment 5 changes the cutoff frequency according to the damping coefficient will be more specifically described.

A and B of FIG. 17 show characteristics provided when connecting LPFs each having a variable cutoff frequency to the differential operation filter (see FIG. 7) of Embodiment 2 above in series and changing the cutoff frequency. In A and B of FIG. 17, Embodiment 2 and Comparison Example 1 are the same as those of FIG. 7. In the figure, the characteristic of Embodiment 2 is shown by the solid line. Variable filters 1 and 2 are characteristics obtained by adding the LPFs to Embodiment 2. The variable filters 1 and 2 are respectively shown by the alternate long and short dash line and alternate long and two short dashes line. The cutoff frequency of the variable filter 2 is lower than that of the variable filter 1. Embodiment 2 can be considered as characteristics obtained without passing through the variable filters.

In the differential operating characteristic according to In Embodiment 2, the phase delay in the unsprung resonance frequency region and the high-frequency noise removal are both achieved. However, there is a problem caused by it in that the gain at about 40 Hz increases, for example. Resonance frequencies are mixed in rotational and axial directions in front, back, left-hand, and right-hand directions of the unsprung portion at about 40 Hz. Those components are overlapped on detection values of the displacement sensor 13 that detects displacements of the suspension in upper and lower directions. Therefore, if the suspension displacement is smaller, there is a fear that the S/N ratio is lowered.

Further, if the suspension displacement is smaller, a degree of contribution of frictional force (mainly static frictional force) of the damper to damping force of the damper increases, and hence the corresponding damping coefficient increases. Then, the suspension and the damper are moved with a characteristic like the large damping coefficient shown in FIG. 16.

In view of this, if the suspension displacement is smaller (in other words, if the damping coefficient is larger), regarding the differential operating characteristic of the damper speed calculation unit 44, the damper speed (not suspension speed) can be estimated with higher accuracy by setting the phase delay to be longer in comparison with a simple differential characteristics. The increase in the phase delay can reduce the gain in a predetermined frequency region (at about 40 Hz in the above) of the differential operating characteristic, and can avoid the problem of the decrease in the S/N ratio described above.

It will be described with reference to A and B of FIG. 17. The variable filter 1 is set to have a gain approximately equal to that of Comparison Example 1 at about 40 Hz and the phase delay in the unsprung resonance frequency region is also approximately equal to that of Comparison Example 1. Thus, if the suspension displacement is smaller (if the damping coefficient is large), the characteristic equivalent to that of Comparison Example 1 at about 40 Hz can be obtained by lowering the cutoff frequency of the LPF. Thus, the above-mentioned problem can be avoided.

Further, if the suspension displacement becomes further smaller, the degree of contribution of friction to the damping force of the damper also further increases and the damping coefficient also further increases. Therefore, as shown in A of FIG. 16, the gain in the unsprung resonance frequency region is further lowered. In this case, for example, as in the characteristics of the variable filter 2 shown in A of FIG. 17, highly accurate estimation whose result is closer to the original damper speed is made possible by further lowering the cutoff frequency of the LPF. Thus, the above-mentioned problem can be avoided.

The merit obtained when the low-pass operation unit 110 according to Embodiment 5 changes the cutoff frequency according to the “damping coefficient” has been described above.

(Regarding Difficulty for Calculating Actual Damping Coefficient)

The above description of the theory about the damping coefficient is a theoretical description about the gain characteristic that varies according to the damping coefficient of the damper. However, in the current state, it is difficult to actually calculate the damping coefficient from two perspectives as follows.

The first one is that the damper speed and the current value are necessary for calculating the damping coefficient in a semi-active damper used in the semi-active suspension system. However, the above-mentioned theory utilizes the damping coefficient for calculating the damper speed, and hence a contradiction occurs. (It should be noted that a provisional damping coefficient can be practically estimated by a method as will be described later.)

The second one is that, even if the damping coefficient can be calculated on the basis of the damper speed and the current value, a response delay of the damper is actually present due to an oil pressure and the damping force has hysteresis. Therefore, even if it is possible to calculate a temporary static damping coefficient, it is difficult to calculate an actual dynamic damping coefficient.

In view of this, it is possible to set the “unsprung vibration level” that is the magnitude of the unsprung vibration that is dominant as damper speed components and practically replace the damping coefficient by it. In Embodiments 6 to 9 below, aspects each using the unsprung vibration level as the vehicle motion information will be described.

### Embodiment 6

FIG. 18 is a block diagram showing a configuration of a suspension displacement processor according to Embodiment 6. A low-pass operation unit 120 in this suspension displacement processor 50D includes an unsprung vibration level calculator 210. The unsprung vibration level calculator 210 calculates an unsprung vibration level on the basis of unsprung acceleration, for example.

Here, the unsprung vibration level means a vibration level that is any one of unsprung acceleration, an unsprung speed, and an unsprung displacement. The unsprung acceleration is detected by an unsprung acceleration sensor (not shown) as described above. Most of acceleration components obtained by the unsprung acceleration sensor indicate vibration components of the unsprung acceleration and contain few frequency components of sprung acceleration unlike the “damper speed” as will be described later. Therefore, the computing unit can accurately calculate an unsprung vibration level. Further, if any information item on the unsprung acceleration, the unsprung speed, and the unsprung displacement is used, they are merely different in unit, and such a difference does not affect the calculation accuracy.

As the unsprung “vibration level” according to this embodiment, an envelope of that vibration amplitude is employed as shown in FIG. 20, for example. As a calculation means for the envelope, processing such as peak hold processing and Hilbert transformation at each predetermined timing is performed on the waveform subjected to full-wave rectification, for example. As a matter of course, it is not limited thereto and various types of means can be used. The unsprung vibration level is not limited to the envelope. For example, the unsprung vibration level may be a vibration amplitude per se of an unsprung resonance frequency signal.

A of FIG. 19 is a block diagram showing a configuration of the low-pass operation unit 120. The low-pass operation unit 120 includes a map 121 and an LPF unit 125. B of FIG. 19 shows an example in which the map 121 is graphically shown. The map 121 is a lookup table showing a correspondence between an unsprung vibration level and a cutoff frequency. In this example, the cutoff frequency is set to increase as the unsprung vibration level becomes higher within a predetermined region of the unsprung vibration level. Out of the predetermined region of the unsprung vibration level, the cutoff frequency is set to constant values of an upper limit value and a lower limit value.

Note that the graph form of the map 121 is not limited to that shown in B of FIG. 19 and may include a curve.

FIG. 21 is a flowchart showing an operation of this suspension displacement processor 50D. The damper speed calculation unit 44 reads a suspension displacement (Step 301), and the unsprung vibration level calculator 210 reads an unsprung acceleration (Step 302). The damper speed calculation unit 44 calculates a temporary damper speed (Step 303), and the unsprung vibration level calculator 210 calculates an unsprung vibration level by determining an envelope as described above with reference to FIG. 20 (Step 304).

The low-pass operation unit 120 refers to the map 121 and calculates a cutoff frequency corresponding to the input unsprung vibration level (Step 305). The LPF unit 125 performs an LPF operation on the input temporary damper speed with the calculated cutoff frequency (Step 306). With this, a final damper speed is output (Step 307).

The damper speed is a differential value of the suspension displacement that is the relative displacement between the sprung and unsprung portions. The damper speed is a relative speed between a sprung speed and the unsprung speed. Therefore, the damper speed mainly includes sprung frequency components and unsprung frequency components. The sprung resonance frequency is sufficiently lower than the unsprung resonance frequency, and hence the damper speed hardly increases due to the sprung vibration and the damper speed easily increases due to the unsprung vibration.

A feature common to all the embodiments of the present invention is that the phase delay in the unsprung resonance frequency region is reduced (compensated) in calculation of the damper speed. However, when most of frequency components of the damper speed are sprung frequency components, the damper speed is very low and it is unnecessary to reduce the phase delay in the unsprung resonance frequency region. In a region in which the damper speed is very low, the signal level of the sprung resonance frequencies relatively increases and the S/N ratio is lowered. Therefore, in this case, it is suitable to prioritize noise removal by calculating a low cutoff frequency.

On the contrary, when the unsprung vibration is large (damper speed is high), the function of the phase delay compensation that is the above-mentioned feature only needs to be exerted.

As described above, in Embodiment 6, the unsprung vibration level is directly calculated on the basis of the unsprung acceleration, and hence the unsprung vibration can be reliably detected. With this, as described above, it is possible to adaptively divide a situation where the output accuracy for the damper speed is prioritized and a situation where the noise removal is prioritized (where the cutoff frequency is lowered). Thus, the control performance is enhanced.

As the modified example of Embodiment 6 above, a low-pass operation unit 120′ as shown in C of FIG. 19 may be provided. This low-pass operation unit 120′ includes a switch 126. The switch 126 selects whether to input an input temporary damper speed into the LPF unit 125 on the basis of the cutoff frequency calculated in Step 305 described above or to prevent it to pass through the LPF unit 125. In other words, the switch 126 functions as a “switching unit” that switches on and off this low-pass operation unit 120.

For example, when the calculated cutoff frequency is an upper limit value thereof, the switch 126 is capable of outputting the temporary damper speed as it is, as a final damper speed.

Note that, although the low-pass operation unit 120 according to Embodiment 6 uses the map 121 for calculating the cutoff frequency, it may calculate the cutoff frequency by calculation using a predetermined arithmetic expression. The same applies to a “map”, which will be seen in each of embodiments below. The arithmetic expression may be used instead of that map.

### Embodiment 7

FIG. 22 is a block diagram showing a configuration of a suspension displacement processor according to Embodiment 7. A different point between Embodiments 6 and 7 is in that an unsprung vibration level calculator 220 in a suspension displacement processor 50E calculates an unsprung vibration level on the basis of a temporary damper speed output from the damper speed calculation unit 44.

FIG. 23 is a block diagram showing a configuration of the unsprung vibration level calculator 220. The unsprung vibration level calculator 220 includes a BPF 201 and a computing unit 202. The BPF 201 extracts frequency components of the unsprung vibration from frequency components of the temporary damper speed obtained by the damper speed calculation unit 44. The computing unit 202 calculates the unsprung vibration level on the basis of the unsprung vibration of the extracted frequency components.

The information used for calculating the unsprung vibration level is not limited to the damper speed. The information used for calculating the unsprung vibration level may be damper acceleration obtained when it is differentiated or may be a damper displacement. However, when the damper speed is utilized, noise components may be increased. Further, when the damper displacement is utilized, the suspension displacement can be utilized as it is. However, the amplitude of low-frequency components relatively increases, and hence a filter having a high low-region ratio in a low-frequency region has to be applied for removing low-frequency components, which makes the filter design difficult. Thus, it is most preferable to utilize the damper speed.

FIG. 24 is a flowchart showing an operation of this suspension displacement processor 50E. The damper speed calculation unit 44 reads a suspension displacement (Step 401), and calculates a temporary damper speed (Step 402). The unsprung vibration level calculator 220 calculates an unsprung vibration level on the basis of a temporary damper speed (Step 403).

The low-pass operation unit 120 refers to the map 121 (see FIG. 19), and calculates a cutoff frequency corresponding to the input unsprung vibration level (Step 404). The LPF unit 125 performs a low-pass operation on the input temporary damper speed with the calculated cutoff frequency (Step 405). With this, a final damper speed is output (Step 406).

In accordance with Embodiment 7, it is unnecessary to provide the unsprung acceleration sensor as in Embodiment 6, for example, and hence the cost increase is prevented.

### Embodiment 8

FIG. 25 is a block diagram showing a configuration of a suspension displacement processor according to Embodiment 8. A different point between Embodiments 7 and 8 is in that the low-pass operation unit 140 in this suspension displacement processor 50F takes in a damping coefficient-corresponding value in addition to an unsprung vibration level, as the vehicle motion information. The damping coefficient-corresponding value is a value corresponding to a change in the damping coefficient of the damper. The damping coefficient-corresponding value is, for example, a current value (voltage value) for causing the damping characteristic to function. In this case, the current value may be an actual current value (or actual voltage value) actually detected by a current detector (or voltage detector) at a current time or may be a control command value to the damper, which is output by the control computing unit 300 (see FIG. 1) at a previous time or at a time before it.

A of FIG. 26 is a block diagram showing a configuration of the low-pass operation unit 140. The low-pass operation unit 140 has a configuration in which a map 122 and a computing unit 141 are added to the configuration of Embodiment 6 shown in FIG. 19.

Here, in general, the damping characteristic (i.e., damping coefficient) of the semi-active damper in the proportional solenoid system becomes larger and the damper becomes harder as the current value becomes larger as described above. On the contrary, the damping coefficient becomes smaller and the damper becomes softer as the current value becomes smaller. Therefore, the damping coefficient can be estimated on the basis of the current value. Note that, in general, a degree of opening of a proportional solenoid valve of the damper depends on a current value obtained when a proportional solenoid is energized.

Further, although not shown in the figure here because a general relationship between the damper speed and the damping force of the semi-active damper is a well-known characteristic, the damping force becomes larger as the damper speed becomes higher. It should be noted that the both are not in a linear relationship, the rate of change of the damping force becomes higher as the damper speed in the region becomes lower, and the rate of change of the damping force becomes lower as the damper speed in the region becomes higher.

B of FIG. 26 shows an example of the map 122. The map 122 shows a relationship between the damping coefficient and the cutoff frequency. In this map 122, the cutoff frequency is set to decrease as the damping coefficient becomes larger within a predetermined region of the damping coefficient. Out of the predetermined region of the damping characteristic, the cutoff frequency is set to the constant values of the upper limit value and the lower limit value. In this case, as described above, the damping coefficient can be replaced by the current value.

Cutoff frequencies a and b calculated by referring to each of the maps 121 and 122 are input into the computing unit 141. The computing unit 141 performs a predetermined arithmetic operation on the basis of the cutoff frequencies a and b, and outputs a final cutoff frequency.

FIG. 27 is a flowchart showing an operation of this suspension displacement processor 50F. The damper speed calculation unit 44 reads a suspension displacement (Step 501), and the low-pass operation unit 140 reads a current value (Step 502). The damper speed calculation unit 44 calculates a temporary damper speed (Step 503), and the unsprung vibration level calculator 220 calculates an unsprung vibration level on the basis of a temporary damper speed (Step 504).

The low-pass operation unit 140 refers to the map 121, and calculates a cutoff frequency a corresponding to the input unsprung vibration level (Step 505). Further, the low-pass operation unit 140 refers to the map 122, and calculates a cutoff frequency b corresponding to an input current value (Step 506). The computing unit 141 reads both cutoff frequencies a and b, and outputs a final cutoff frequency on the basis of them (Step 507). The LPF unit 125 performs a low-pass operation on the input temporary damper speed at the final cutoff frequency (Step 508). With this, a final damper speed is output (Step 509).

Here, as shown in A of FIG. 16, it can be seen that the transfer characteristic from the suspension speed to the damper speed depends on a value of the damping coefficient. This damping coefficient is determined by a plurality of types (here, two types) of vehicle motion information, which are the damper speed and the current value as described above (where dynamic characteristic is ignored as will be described later). Therefore, in the low-pass operation unit 140, changing the cutoff frequency using two types of vehicle motion information rather than changing it using only one type of vehicle motion information can calculate a damper speed in a state closer to the actual characteristic. Thus, the output accuracy for the damper speed is enhanced and the control performance is enhanced.

(Specific Example of Low-Pass Operation Unit According to Embodiment 8)

A to C of FIG. 28 are diagrams for describing computing examples of the computing unit 141 in the low-pass operation unit 140 according to Embodiment 8 above.

### Embodiment 8-1

A computing unit in an aspect shown in A of FIG. 28 is constituted of a low selector 141a. The low selector 141a reads both cutoff frequencies a and b, compares them, and selects and outputs the lower cutoff frequency.

In view of the purpose common to the embodiments, specifically, the purpose of calculating a damper speed with a reduced phase delay in the unsprung resonance frequency region, a state without the LPF is originally a state most suitable for that purpose. In contrast, regarding Embodiment 8-1, it may be better to add a filter and delay the phase in some situations. In this case, it is only necessary to prioritize one having a lower cutoff frequency.

### Embodiment 8-2

A low-pass operation unit in an aspect shown in B of FIG. 28 includes a map 123 instead of the above-mentioned map 122. FIG. 29 shows an example the map 123. The map 123 is for describing a correspondence between the damping coefficient (i.e., current value) and a ratio to a cutoff frequency (hereinafter, referred to as reference cutoff frequency) that is determined by the map 121 on the basis of the unsprung vibration level. In other words, the low-pass operation unit refers to the map 123, and outputs a ratio value to the reference cutoff frequency on the basis of the input current value.

The graph form of the map 123 is linear in FIG. 29. However, the graph form of the map 123 may be curve or non-linear.

The low-pass operation unit includes a multiplier 141b as the computing unit 141. The multiplier 141b reads the reference cutoff frequency and the ratio value. The multiplier 141b outputs a final cutoff frequency obtained by multiplying the input reference cutoff frequency by the input ratio value.

### Embodiment 8-3

As in the concept of the above-mentioned aspect 8-2, a low-pass operation unit in an aspect shown in C of FIG. 28 includes a map 124 instead of the map 121 and further includes the above-mentioned map 122 (see B of FIG. 26). Although not shown in the figure, the map 124 is for describing a relationship between an unsprung vibration level and a ratio to a reference cutoff frequency, which is determined by the map 122 on the basis of the current value. In other words, the low-pass operation unit refers to the map 124, and outputs a ratio value to the reference cutoff frequency on the basis of the input unsprung vibration level. The multiplier 141b outputs a final cutoff frequency obtained by multiplying the reference cutoff frequency by the ratio value.

As described above, the damper speed and the current value are not in a linear relationship, the rate of change of the current value becomes lower as the damper speed in the region becomes higher, and the rate of change of the current value becomes higher as the damper speed in the region becomes lower. Due to the presence of such characteristics, the low-pass operation unit can also perform the following processing other than Embodiments 8-1, 8-1, and 8-3 above. For example, the low-pass operation unit may basically change the cutoff frequency according to the unsprung vibration level and further change the cutoff frequency according to the current value in a region in which the unsprung vibration level is equal to or lower than a predetermined level. Due to such processing, the control performance is further enhanced.

Specifically, the low-pass operation unit only needs to further lower the cutoff frequency as the current value becomes larger, in a region in which the unsprung vibration level is low, that is, the damper speed is low, for example.

Otherwise, as a modified example of the aspects of Embodiments 8-2 and 8-3, subtraction may be, for example, used other than multiplication. For example, in either one of the two maps, the reference cutoff frequency is determined on the basis of the unsprung vibration level or the current value. In the other map, a subtraction value for the determined reference cutoff frequency is associated with the current value or the unsprung vibration level. Then, a subtractor serving as the computing unit 141 (see FIG. 26) may perform processing of subtracting the subtraction value, which is determined using the other map, from the reference cutoff frequency, which is determined using the one map.

### Embodiment 9

FIG. 30 is a block diagram showing a configuration of a suspension displacement processor according to Embodiment 9. In Embodiment 9, the configuration of an unsprung vibration level calculator 230 in this suspension displacement processor 50G is different from the above-mentioned embodiments. Further, the aspect of the low-pass operation unit 120 is an aspect in which the current value is not read (as in FIG. 22).

FIG. 31 is a block diagram showing a configuration of the unsprung vibration level calculator 230. The unsprung vibration level calculator 230 includes elements similar to the BPF 201 and the computing unit 202 in the unsprung vibration level calculator 220 shown in FIG. 23. The unsprung vibration level calculator 230 further includes a map 203 and an LPF unit 204. The map 203 describes a correspondence between an input temporary damper speed and a cutoff frequency of the LPF unit 204 at the subsequent stage. In other words, in the unsprung vibration level calculator 230, the LPF unit 204 performs an LPF operation at a cutoff frequency calculated according to the temporary damper speed using the map 203.

In other words, the unsprung vibration level calculator 230 can calculate a highly accurate unsprung vibration level by LPF processing at the cutoff frequency corresponding to the input temporary damper speed.

FIG. 32 is a flowchart showing an operation of this suspension displacement processor 50G. Here, Step 604 is processing different from those of the flowchart shown in FIG. 24. In Step 604, the unsprung vibration level calculator 230 performs an LPF operation (variable LPF operation) at a cutoff frequency corresponding to the temporary damper speed, and outputs an unsprung vibration level from which noise has been removed, to the low-pass operation unit 120.

When the unsprung vibration level is low, the damper speed is low. Therefore, it is necessary to calculate the unsprung vibration level in a state in which the S/N ratio is low, and the unsprung vibration level is likely to fluctuate at a high frequency due to noise. There is a fear in that this fluctuation may affect a result of output of the final damper speed. In accordance with the configuration of Embodiment 9, the fluctuation of the unsprung vibration level at a high frequency is reduced, and hence the low-pass operation unit 120 can output a final damper speed with the reduced fluctuation.

Note that the low-pass operation unit 120 according to Embodiment 9 may have functions similar to those of the low-pass operation unit 140 according to Embodiment 8 and further read a current value and change a cutoff frequency.

### Embodiment 10

FIG. 33 is a block diagram showing a configuration of a suspension displacement processor according to Embodiment 10. A different point between a suspension displacement processor 50H according to Embodiment 10 and Embodiment 7 above (see FIG. 22) is in that a damper speed vibration level calculator 310 is provided instead of the unsprung vibration level calculator 220 of Embodiment 7.

The damper speed vibration level calculator 310 reads a temporary damper speed output from the damper speed calculation unit 44 and calculates a damper speed vibration level on the basis of it. The damper speed vibration level calculator 310 outputs it to the low-pass operation unit 120 as vehicle motion information. The calculation of the damper speed vibration vibration level is typically realized by calculating an envelope as in the above-mentioned unsprung vibration level calculation.

If a calculation delay (phase delay) of the damper speed occurs but does not become a problem, there is no problem even when the cutoff frequency of the LPF in calculation of the damper speed vibration level is set to be low. On the contrary, if a phase delay occurs, which becomes a problem, it is favorable to set the cutoff frequency of the LPF in calculation of the damper speed vibration level to be high or to pass the damper speed as it is.

FIG. 34 is a flowchart showing an operation of this suspension displacement processor 50H. In this flowchart, processing different from the operation (see FIG. 24) of the suspension displacement processor 50E according to Embodiment 7 is Steps 703 to 705. In other words, the damper speed vibration level calculator 310 calculates a damper speed vibration level (Step 703). The low-pass operation unit 120 reads a damper speed vibration level, calculates a cutoff frequency corresponding to the damper speed vibration level (Step 704), and performs an LPF operation on the damper speed at this cutoff frequency (Step 705).

This suspension displacement processor 50H directly determines a vehicle motion state in a region in which the damper speed is very low, which deteriorates the S/N ratio of the damper speed, on the basis of the damper speed vibration level, and hence the damper speed can be reliably detected. Thus, a deterioration of the control performance due to the deterioration of the S/N ratio can be avoided.

It should be noted that, as described above, frequency components of the damper speed contain not only unsprung frequency components but also sprung frequency components. Therefore, for calculating a final damper speed with further high accuracy, it is favorable to use the unsprung vibration level as the vehicle motion information as in Embodiments 6 to 9.

### Embodiment 11

FIG. 35 is a block diagram showing a configuration of a suspension displacement processor according to Embodiment 11. A different point between a suspension displacement processor 50I according to Embodiment 11 and Embodiment 7 (see FIG. 22) is in that a plurality of LPFs 70 and a switching means 80 are provided instead of the low-pass operation unit 120 of Embodiment 7 and that the real time property is not prioritized unlike each of the above-mentioned embodiments.

Each LPF of the plurality of LPFs 70 has different cutoff frequencies. The switching means 80 selectively switches between the plurality of LPFs 70 for use according to the vehicle motion information. In this example, the unsprung vibration level calculated by the unsprung vibration level calculator 220 is used as the vehicle motion information.

FIG. 36 is a flowchart showing an operation of this suspension displacement processor 50I. In this flowchart, processing different from the operation (see FIG. 24) of the suspension displacement processor 50E according to Embodiment 7 is Steps 804 and 805. The switching means 80 selects one of the plurality of LPFs 70 according to the input unsprung vibration level (Step 804), and performs an LPF operation on the temporary damper speed using this LPF (Step 805).

In Embodiment 11, the real time property is not prioritized unlike each of the above-mentioned embodiments while a highly accurate final damper speed can be output.

This suspension displacement processor 50I may calculate the final damper speed while linearly complementing the outputs of those LPFs.

The vehicle motion information may be a damper speed vibration level as in Embodiment 10 instead of the unsprung vibration level.

### Embodiment 12

FIG. 37 is a block diagram showing a configuration of a suspension displacement processor according to Embodiment 12. In a suspension displacement processor 50J according to Embodiment 12, the damper speed calculation unit 44 is provided at the subsequent stage of the low-pass operation unit 120. The damper speed calculation unit 44 waits for the differential operating characteristic shown in Embodiment 2 or 3 above (or may be Embodiment 1, 4).

FIG. 38 is a flowchart showing an operation of this suspension displacement processor 50J. The low-pass operation unit 120 reads a suspension displacement (Step 901). The unsprung vibration level calculator 230 reads an unsprung acceleration from the unsprung acceleration sensor (Step 902), and calculates an unsprung vibration level on the basis of it as vehicle motion information (Step 903).

The low-pass operation unit 120 calculates a cutoff frequency on the basis of the unsprung vibration level (Step 904), and performs an LPF operation on the suspension displacement at this cutoff frequency (Step 905). The damper speed calculation unit 44 reads this suspension displacement, calculates a damper speed using the differential operating characteristic (Step 906), and outputs it as a final damper speed (Step 907).

In this manner, if the order of the damper speed calculation unit 44 and the low-pass operation unit 120 is reversed, the transfer function between them is the same and effects similar to those of each of the above-mentioned embodiments can be provided.

The vehicle motion information is not limited to the unsprung vibration level and may be replaced by various types of information as described above. The unsprung vibration level calculator 210 may be replaced by the damper speed vibration level calculator 310.

### Embodiment 13

A and B of FIG. 39 are block diagrams each showing a configuration of the damper speed calculation unit in the suspension displacement processor according to Embodiment 13. In these embodiments, the differential operating characteristic of the damper speed calculation unit is divided into two arithmetic characteristics.

For example, a damper speed calculation unit 45 shown in A of FIG. 39 includes a first computing unit 45a including a BPF characteristic and a second computing unit 45b. The second computing unit 45b includes a differential operating characteristic including a gain characteristic having a gradient larger than the gradient of the gain characteristic of the exact differential in the unsprung resonance frequency region. The differential operating characteristic of the second computing unit 45b may include any of the characteristics in Embodiments 1 to 4 above.

In a damper speed calculation unit 145 shown in B of FIG. 39, the order of the first computing unit 45a and the second computing unit 45b shown in A of FIG. 39 is reversed.

Even with such a damper speed calculation unit 145, effects similar to those of Embodiments 1 to 4 above can be provided.

### Other Embodiments

The present invention is not limited to the above-mentioned embodiments and other various embodiments can be realized.

The differential operating characteristic in Embodiments 1 to 3 above, for example, includes the phase characteristic whose phase becomes 90 deg that is the same as the exact differential at the resonance frequency (e.g., 12 Hz) of the unsprung resonance frequency region. However, the phase does not necessarily need to be 90 deg at that unsprung resonance frequency and the phase may be set to be 90 deg±α deg at the unsprung resonance frequency.

In each of Embodiments 8 and 9 above (see FIGS. 25, 30, etc.), the current value (damping coefficient) is used as one of the two vehicle motion information items. In this case, the current value is the control command value output by the control computing unit 300 or the actual current value. However, the damping coefficient may be a damping coefficient calculated on the basis of a temporary damper speed output from the damper speed calculation unit. Although the damping characteristic actually has hysteresis due to influence of the dynamic characteristic, the cutoff frequency of the low-pass operation unit can be changed according to this damping coefficient by, for example, calculating the damping coefficient on the basis of data of a static characteristic of the damping characteristic (where hysteresis is ignored).

It is also possible to create a damper model considering not only the static characteristic but also the dynamic characteristic of the damping characteristic and calculate the damping coefficient considering also hysteresis according to this model.

As modified examples of Embodiments 8 and 9 above, the damper speed may be used as the vehicle vibration information instead of the unsprung vibration level in Embodiment 10 (see FIG. 33) or other information may be used. The same applies to Embodiments 8-1, 8-2, and 8-3 shown in FIG. 28.

For example, in the descriptions of Embodiments 8 and 9, the damping coefficient of the semi-active damper with the proportional solenoid valve becomes larger as the current value becomes larger. However, with some proportional solenoid valves, the damping coefficient may become smaller as the current value becomes larger.

In the above-mentioned embodiments, the four-wheel vehicle has been exemplified as the vehicle. However, the technology of each of the above-mentioned embodiments is also applicable to a two-wheel vehicle, a train vehicle, and the like.

Two feature portions of the feature portions of the aspects described above can also be combined as shown below.

For example, the unsprung vibration level calculator 210 shown in FIG. 18 may read a wheel speed from the wheel speed sensor 15 rather than reading an unsprung acceleration from the unsprung acceleration sensor. In this case, the unsprung vibration level calculator may output a signal obtained by extracting frequency components due to the unsprung vibration from the signal of the wheel speed. Note that, in this case, the unsprung vibration level can be determined irrespective of whether or not the wheel speed is differentiated. It should be noted that adjustment of a unit system is necessary.

The modified example of Embodiment 6 shown in C of FIG. 19 is also applicable to the low-pass operation unit of each of Embodiments 5 and 7 to 13 described below.

For example, the unsprung vibration level calculator according to Embodiment 30 shown in FIG. 30 reads a temporary damper speed. However, the unsprung acceleration as shown in FIG. 18 may be used as information instead of this temporary damper speed or the wheel speed may be otherwise used.

The aspect shown in Embodiment 13A or 13B may be applied to Embodiments 5 to 12.

### DESCRIPTION OF SYMBOLS

20 suspension control device
100 signal computing unit
300 control computing unit
42, 44, 45, 145 damper speed calculation unit
50, 50A, 50B, 50C, 50D, 50E, 50F, 50G, 50H, 50I, 50J suspension displacement processor
70 LPFs
80 switching means
100 suspension control system
110, 120, 120′, 140 low-pass operation unit
121, 122, 123, 124, 203 map
126 switch
141a low selector
141b multiplier
141 computing unit
204 LPF unit
210, 220, 230 unsprung vibration level calculator
310 damper speed vibration level calculator

1. A signal processing device that reads a suspension displacement and outputs a damper speed, comprising
a damper speed calculation unit that differentiates the suspension displacement, using a differential operating characteristic including a gain characteristic having a gradient larger than a gradient of a gain characteristic of an exact differential in an unsprung resonance frequency region.

2. The signal processing device according to claim 1, wherein
the damper speed calculation unit uses the differential operating characteristic further including a gain characteristic having a gradient smaller than the gradient of the gain characteristic of the exact differential in a frequency region between a sprung resonance frequency region and the unsprung resonance frequency region.

3. The signal processing device according to claim 2, wherein
the damper speed calculation unit uses a differential operating characteristic including a phase characteristic having a phase that becomes the same as a phase of the exact differential in the unsprung resonance frequency region.

4. The signal processing device according to claim 1, further comprising
a low-pass operation unit into which the damper speed from the damper speed calculation unit is input, the low-pass operation unit having a cutoff frequency variable according to vehicle motion information.

5. The signal processing device according to claim 4, further comprising
a switching unit that switches on and off the low-pass operation unit on the basis of a cutoff frequency calculated according to the vehicle motion information.

6. The signal processing device according to claim 1, further comprising
a low-pass operation unit into which the suspension displacement is input, the low-pass operation unit having a cutoff frequency variable according to vehicle motion information, wherein
the suspension displacement subjected to a low-pass operation by the low-pass operation unit is input into the damper speed calculation unit.

7. The signal processing device according to claim 4, further comprising
a calculator that calculates an unsprung vibration level as the vehicle motion information.

8. The signal processing device according to claim 7, wherein
the calculator calculates the unsprung vibration level on the basis of unsprung acceleration.

9. The signal processing device according to claim 7, wherein
the calculator includes a low-pass filter unit having a cutoff frequency variable according to unsprung acceleration.

10. The signal processing device according to claim 7, wherein
the calculator calculates the unsprung vibration level on the basis of the damper speed calculated by the damper speed calculation unit.

11. The signal processing device according to claim 10, wherein
the calculator includes a low-pass filter unit having a cutoff frequency variable according to the damper speed calculated by the damper speed calculation unit.

12. The signal processing device according to claim 4, wherein
the low-pass operation unit calculates the cutoff frequency on the basis of a plurality of types of vehicle motion information.

13. The signal processing device according to claim 12, wherein
the low-pass operation unit calculates a cutoff frequency on the basis of an unsprung vibration level and a damping coefficient-corresponding value corresponding to a change in damping coefficient of a damper.

14. The signal processing device according to claim 13, wherein
the low-pass operation unit calculates a cutoff frequency on the basis of a cutoff frequency calculated on the basis of the unsprung vibration level and a cutoff frequency calculated on the basis of the damping coefficient-corresponding value.

15. The signal processing device according to claim 14, wherein
the low-pass operation unit includes a low selector that outputs the cutoff frequency through low select processing.

16. The signal processing device according to claim 13, wherein
the low-pass operation unit includes a multiplier that calculates a ratio value on the basis of the damping coefficient-corresponding value and multiplies a reference cutoff frequency by the ratio value, the reference cutoff frequency being calculated on the basis of the unsprung vibration level.

17. The signal processing device according to claim 13, wherein
the low-pass operation unit includes a multiplier that calculates a ratio value on the basis of the unsprung vibration level and multiplies a reference cutoff frequency by the ratio value, the reference cutoff frequency being calculated on the basis of the damping coefficient-corresponding value.

18. The signal processing device according to claim 1, further comprising:
a plurality of low-pass filters that each perform low-pass filtering on the damper speed from the damper speed calculation unit at a plurality of different cutoff frequencies; and
a switching means that selectively switches between the plurality of low-pass filters for use according to vehicle motion information.

19. The signal processing device according to claim 1, wherein
the damper speed calculation unit uses the differential operating characteristic further including a band elimination filter characteristic in a frequency region higher in frequency than the unsprung resonance frequency region.

20. The signal processing device according to claim 19, wherein
the damper speed calculation unit uses the differential operating characteristic further including the band elimination filter characteristics arranged in series at respective frequencies higher in frequency than the unsprung resonance frequency region.

21. The signal processing device according to claim 1, wherein
the damper speed calculation unit uses the differential operating characteristic further including a high-pass filter characteristic having a cutoff frequency lower than that of the sprung resonance frequency region.

22. A suspension control device, comprising:
a damper speed calculation unit that differentiates a suspension displacement, using a differential operating characteristic including a gain characteristic having a gradient larger than a gradient of a gain characteristic of an exact differential in an unsprung resonance frequency region, and outputs a damper speed; and
a control computing unit that generates a control command value for controlling a damper on the basis of the damper speed.

23. A signal processing method, comprising:
reading a suspension displacement; and
differentiating the read suspension displacement, using a differential operating characteristic including a gain characteristic having a gradient larger than a gradient of a gain characteristic of an exact differential in an unsprung resonance frequency region.
